(19) United States
(12) Patent Application Publication
(10) Pub. No.: US 2013/0039553 A1
(43) Pub. Date: Feb. 14, 2013

(54) METHOD FOR OBTAINING A BLOOD FLOW PARAMETER

(71) Applicant: Birgitte Fuglsang Kjølby, Risskov (DK)

(72) Inventor: Birgitte Fuglsang Kjølby, Risskov (DK)

(73) Assignee: AARHUS UNIVERSITET, Arhus C (DK)

(21) Appl. No.: 13/583,584

(22) PCT Filed: Mar. 7, 2011
(86) PCT No.: PCT/DK11/50070

§ 371 Date: Sep. 7, 2012

(30) Foreign Application Priority Data
Mar. 9, 2010 (DK) PA 2010 70091

(51) Int. Cl. G06K 9/00

(52) U.S. Cl. 382/128

(57) ABSTRACT

The present invention relates to a method for obtaining a blood flow parameter. More particularly a method is presented wherein a first concentration curve is deconvolved with a second concentration curve and wherein a characteristic frequency is determined by an analysis in the frequency domain, the characteristic frequency being a frequency above which noise dominates the result of said deconvolution. A filter having the characteristic frequency is applied on the result of the deconvolution so as to disregard high frequency components, and the filtered result of the deconvolution is processed into a blood flow parameter. In an advantageous embodiment, the characteristic frequency may be dependent on a shape and/or width of an arterial input function and/or other parameters. The invention furthermore relates to a computer program product and a system for obtaining a blood flow parameter.

### FIELD OF THE INVENTION

The present invention relates to a method for obtaining a blood flow parameter, e.g. a measure indicative of the cerebral blood flow, a corresponding computer system, and a corresponding computer program product.

### BACKGROUND OF THE INVENTION

Perfusion measurements by dynamic susceptibility contrast magnetic resonance imaging (DSC-MRI) has become an important tool in the study and management of neurological diseases, in particular acute stroke which is a medical emergency that may lead to death of the patient. Increasingly, tissue mean transit time (MTT) characteristics or normalized cerebral blood flow (CBF) values are compared across subjects and studied to establish perfusion threshold that may guide the selection of patients for thrombolytic treatment.

In pursuing this, perfusion measurements must be optimized to detect and distinguish subtle levels of hypoperfusion, and standardized to allow comparison and application of results across academic centers.

When computing perfusion weighted imaging (PWI) maps, their accuracy and precision are determined by:
1) deconvolution technique, and
2) the regularization applied during deconvolution to reduce the effects of experimental noise.

Deconvolution is most commonly performed using standard singular value decomposition (sSVD) introduced by Østergaard et al. Magn Reson Med 1996; 36(5):715-25, or block-circulant SVD (cSVD) introduced by Wu et al. in Magn Reson Med 2003; 50(1):164-174 to allow for delay insensitive CBF and MTT estimates.

Irrespective of technique, deconvolution is extremely noise sensitive, as it enhances the high frequency noise components, and regularization is necessary. Ideally, regularization only removes noise components and not components of the underlying function, but for low signal to noise ratios (SNR) this is impossible. The strength of the regularization is determined by the regularization level which must be optimized for its specific use in order to produce the optimal result.

The regularization approach profoundly affects the accuracy and precision of estimated perfusion parameters and must therefore be carefully optimized for the experimental setting. It is currently also unclear whether the range of sample rates (TR) and available signal to noise ratios (SNR) in hitherto reported clinical studies bias reported perfusion indices—let alone how such bias may be corrected.

Furthermore, regularization optimizations have been based on a single gamma variate model of the arterial input function (AIF). Contrast injection protocol and patient cardiovascular status, however, cause large variations in AIF shape among patients, influencing the perfusion estimates. Such variations will most likely also make meaningful inter-subject comparisons quite difficult.

Hence, an improved method for obtaining a blood flow parameter would be advantageous, and in particular a more efficient and/or reliable method would be advantageous.

### OBJECT OF THE INVENTION

It is a further object of the present invention to provide an alternative to the prior art.

In particular, it may be seen as an object of the present invention to provide a method for obtaining a blood flow parameter that solves the above mentioned problems of the prior art with regularization and/or deconvolution.

### SUMMARY OF THE INVENTION

Thus, the above described object and several other objects are intended to be obtained in a first aspect of the invention by providing a method for obtaining a blood flow parameter (F), including the steps of
identifying a first concentration curve (c_t) representing a convolution of a second input concentration curve (c_a) convolved with a residue function (R),
performing a deconvolution the first concentration curve (c_t) with the second input concentration curve (c_a)
determining a characteristic frequency in a frequency domain, as a frequency above which noise dominates the result of the said deconvolution, said characteristic frequency being obtained by an analysis performed in the frequency domain,
applying a filter on said result of the deconvolution (R_pw), the filter having the characteristic frequency in the frequency domain thereby, at least partly, disregarding high frequency components in the frequency domain, and
processing the filtered result of the deconvolution into the blood flow parameter (F).

The invention is particularly, but not exclusively, advantageous for providing a method for obtaining a blood flow parameter using regularization that is more stable and/or reliable. In particularly, the regularization according to the present invention may be optimized for precision (random error) at the expense of accuracy (systematic bias). This may be obtained by determining the characteristic frequency in the frequency domain that results in an optimum spectrum of the residue function at the highest frequency before the spectral information is masked in noise.

In large cohort studies, the present invention facilitate to use the same characteristic frequency (e.g. cut-off) for all patients, which allows for a comparison with reduced bias on the estimates caused by differences in arterial input functions (AIF) and SNR. It is contemplated that this may increase the efficiency of predictive models due to less method-induced variation between patients. Advantageously, this may also facilitate improved comparison over time for a single patient.

It should also be emphasized that the use of Fourier Transform (FT) is relatively fast compared to SVD in terms of computation speed. For example, compared to oSVD (cSVD with an oscillation index (OI), commonly applied for regularization, FT allows for increased computational speed (up to a factor of two). Furthermore, a more intuitive filter design is applied, such as the Fermi filter.

The proposed regularization level according to the present invention may be global for each patient, i.e. it is contemplated that a global regularization level generally is preferable because voxel-wise optimization and thereby different regularization thresholds across an image introduce different accuracy and precision in neighboring voxels which will appear as noise in the final image. This inherent problem of for example SVD-based methods is thereby avoided by the present invention.

For a plurality of blood flow parameters obtained for a plurality of voxels, which are spatially arranged in a well defined manner, such as a plurality of voxels in an organ, an image may be generated based on the obtained blood flow parameters. The image may in exemplary embodiments be a two-dimensional image or a three-dimensional image.

The noise includes inherent experimental noise, such as 1/f-noise and thermal noise, and noise contributions arising from artifacts, such as aliasing, introduced during the processing of the concentration curves.

The invention may be applied to concentration curves obtained from magnetic resonance (MR) measurements, such as perfusion measurements by dynamic susceptibility contrast magnetic resonance imaging (DSC-MRI). However, the invention might also be applied to concentration curves obtained with other experimental techniques, including computed tomography (CT), positron emission tomography (PET), and/or ultrasound (US). The concentration curves may be provided using contrast agents, where contrast agent is broadly construed to include any substance (gas, fluid or suspension, e.g., of cells) capable of producing a contrast in an experimental technique, such as the above mentioned techniques. Examples of contrast agents include paramagnetic molecules or elements for MR, radioactive isotopes for PET, air bubbles for US, or naturally occurring or labelled red blood cells for intravital microscopy. The contrast agent may be a naturally occurring element or molecule, such as in the case of arterial spin-labelling, where water in a volume of inflowing blood already being present in the body may be used as contrast agent by changing the net magnetization of the water in the volume of blood.

The blood flow parameter may be a cerebral blood flow parameter, but it is contemplated, that the blood flow parameter might also relate to other organs of a human or an animal, where the passage of a bolus, can be measured. Bolus is in the present context understood to be a spatially defined concentration variation of a contrast agent. A bolus may, as an example, be a relatively high concentration of a contrast agent in a limited section of an artery. The bolus may thus move along the artery and transit organs, such as the brain, and be traced by any of the above mentioned experimental techniques.

The blood flow parameter includes blood flow, but also includes other parameters related to blood flow, such as mean transit time (MTT), blood volume or flow heterogeneity. These parameters may also be known in the field as hemodynamic indices.

It is to be understood, that the first concentration curve (c_t) may be proportional to a convolution of a second input concentration curve (c_a) convolved with a residue function (R).

The use of an embodiment of the invention may include providing information as such which is then subsequently used for diagnosing a disease in which ‘hemodynamic indices’ are altered, in a single patient. Said disease including, but not restricted to cerebrovascular disease (including acute stroke), and neurodegenerative diseases, including all forms of dementia.

In another embodiment according to invention, said analysis further comprises evaluation of the influence of noise on the deconvoluted data and/or the blood flow parameter. The analysis may comprise evaluation of a signal-to-noise ratio (SNR) of the result of the deconvolution, a mean transit time (MTT), a CNR (contrast-to-noise ratio), a precision of the blood flow parameter and/or an accuracy of the blood flow parameter. The analysis may comprise determining a threshold for the signal-to-noise ratio (SNR) of the result of the deconvolution.

In yet another embodiment according to invention, the characteristic frequency is dependent on any one of: a shape and/or width of an arterial input function (AIF), a signal-to-noise ratio (SNR) of the result of the deconvolution, a sampling rate (TR), a mean transit time (MTT), and/or a CNR (contrast-to-noise ratio).

In still another embodiment according to invention, the characteristic frequency is determined by a look up table (LUT). A possible advantage of determining the characteristic frequency by a look up table (LUT), is that once the look up table has been established, a subsequent determination of the characteristic frequency can be performed efficiently in terms of time and processing power. Furthermore, the look up table might, as long as the same look up table is used, ensure use of the same characteristic frequency each time a blood flow parameter is obtained, if similar conditions are present.

In another embodiment according to invention, the filter is a continuous filter. A possible advantage of having a continuous filter, such as a smooth filter, is that the filter itself may be designed so as not to introduce oscillations in a time domain of the filtered data. It may be advantageous for further analysis of the result of the deconvolution, such as flow heterogeneity, that the result of the deconvolution does not have oscillations introduced by the filter. In a specific embodiment, the continuous filter is Fermi filter, being a filter shaped as a Fermi function, Fermi_func, given as

Fermi_func(omega)=(1+exp(−kappa/omega_opt))/(1+exp(kappa*[|omega|−omega_opt]))

where kappa defines the width of the filter, and omega_opt is the characteristic frequency, which we also refer to as cut-off frequency.

In yet another embodiment according to invention, the filter is a step function. A step function may be more simple to implement, since values above the cut-off frequency may simply be discarded while those below are used for further analysis. Furthermore, the shape of the step function may be determined by a single parameter, the characteristic frequency.

In another embodiment according to invention, the deconvolved data (R_pw) below the characteristic frequency is fitted to a mathematical model, and wherein the values of the fit above the characteristic frequency are used for processing the perfusion data into a blood flow parameter, an image, or a clinical perfusion parameter. A possible advantage of this embodiment is that the otherwise underestimated area under the curve R_pw(omega), may be estimated with higher accuracy by including values obtained by the fit. The embodiment may utilize the relatively high signal to noise ratio below the characteristic frequency in order to estimate the values in the region above the characteristic frequency where the data values are corrupted by the noise and hence not otherwise accessible. In consequence, an advantage of this embodiment may be that information originally corrupted by noise can be estimated by a model and included in further processing.

In another embodiment according to invention, the characteristic frequency in the spectral domain is chosen so as to optimise precision of said blood flow parameter. An advantage of optimizing the precision of said blood flow parameter could be higher reproducibility, and hence a better foundation for comparing the blood flow parameter for different voxels, subjects or points in time. In the present context a subject is understood to be any patient, person, animal, organ, tissue or the like wherein a blood flow parameter can be obtained by a method according to the present invention. Voxel is commonly known in the art to represent a volume element.

In a further embodiment according to invention, the characteristic frequency in the spectral domain is chosen so as to favour precision of the blood flow parameter at the expense of proximity to true values. An advantage of optimizing the precision of said blood flow parameter could be higher reproducibility, and hence a better foundation for comparing the blood flow parameter for different voxels, subjects or points in time. Although proximity to true values in principle is sought after, it may be advantageous to optimize in favour of precision at the expense of proximity to true values since a characteristic frequency chosen so as to optimize precision leads to a better foundation for comparisons compared to an optimization in terms of a proximity to true values.

In another embodiment according to the invention, the characteristic frequency might be chosen so as to optimize the ability to discriminate between blood flow parameters obtained from different sets of first- and second concentration curves, where the true values of the blood flow parameters are non-similar. For realistic sets of first- and second concentration curves, this may involve choosing the characteristic frequency so as to obtain an optimized trade-off between precision and proximity to true values.

In another embodiment according to invention, the step of identifying a first concentration curve further includes identifying a plurality of concentration curves each corresponding to a voxel within a plurality of voxels, and wherein the characteristic frequency is determined globally for the plurality of voxels. This may be favourable since a different threshold for different voxels, which might introduce unnecessary bias, is avoided.

In another embodiment according to invention, the step of identifying a first concentration curve further includes identifying a plurality of concentration curves each corresponding to a subject within a plurality of subjects, and wherein the characteristic frequency is determined globally for the plurality of subjects. An advantage of this embodiment may be that this embodiment does not introduce different biases for different subjects, and is hence optimized for comparison among a plurality of subjects. This may be advantageous for detecting changes in hemodynamic indices, such as hemodynamic indices in diseases including, but not limited to, cerebrovascular disease (including acute stroke), and neurodegenerative diseases, including all forms of dementia.

In another embodiment according to invention, the step of identifying a first concentration curve further includes identifying a plurality of concentration curves each corresponding to a point in time within a plurality of points in time, and wherein the characteristic frequency is determined globally for the plurality of points in time. An advantage of this embodiment may be that this embodiment does not introduce bias, and is hence optimized for comparison of different measurements over time, and hence for investigating developments over time. This may be advantageous for detecting changes over time for a single subject or a group of subjects, with respect to hemodynamic indices, such as hemodynamic indices in diseases including, but not limited to, cerebrovascular disease (including acute stroke), and neurodegenerative diseases, including all forms of dementia.

In another embodiment according to invention, the blood flow parameter is representative of a perfusion parameter.

According to a second aspect of the invention, there is presented a computer program product being adapted to enable a computer system comprising at least one computer having a data storage means associated therewith to operate a processor arranged for carrying out a method according to the first aspect of the invention.

According to a third aspect of the invention, there is presented a system for obtaining a blood flow parameter (F), the system comprising at least one computer having a data storage means associated therewith to operate a processor arranged for carrying out a method according to according to the first aspect of the invention.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

FIG. 1 shows an illustration of deconvolution in the Fourier domain,

FIG. 2 shows a look up table (LUT),

FIG. 3 shows CBF and MTT discrimination,

FIG. 4 shows apparent CBFs in group studies as a function of the true CBF for different regularization schemes,

FIGS. 5A-B show the real parts of the spectra of three residue functions,

FIGS. 5C-D show the accumulated spectra of three residue functions,

FIG. 6 shows the real and imaginary part of the spectra c_t(omega), c_a(omega) and R(omega) for TR=3 s, sigma_AIF=3 s and MTT=6 s,

FIG. 7 shows four plots showing the eigenvalues as a function of matrix index number in the eigenvalue matrix,

FIG. 8 shows the regularization filter for four methods,

FIGS. 9-10 show patient data,

FIG. 11 shows MTT values which are increasing towards the centre of the circle,

FIG. 12 shows the CBF estimates for different widths of the Fermi filter.

FIGS. 13-14 shows R_pw(omega) and Fermi filters for different widths,

FIG. 15 shows a comparison of the two different methods to obtain the optimal regularization level in FT, and

FIG. 16 shows a flow chart.

The invention will now be described in more detail with regard to the accompanying figures. The figures show one way of implementing the present invention and is not to be construed as being limiting to other possible embodiments falling within the scope of the attached claim set.

### DETAILED DESCRIPTION OF AN EMBODIMENT

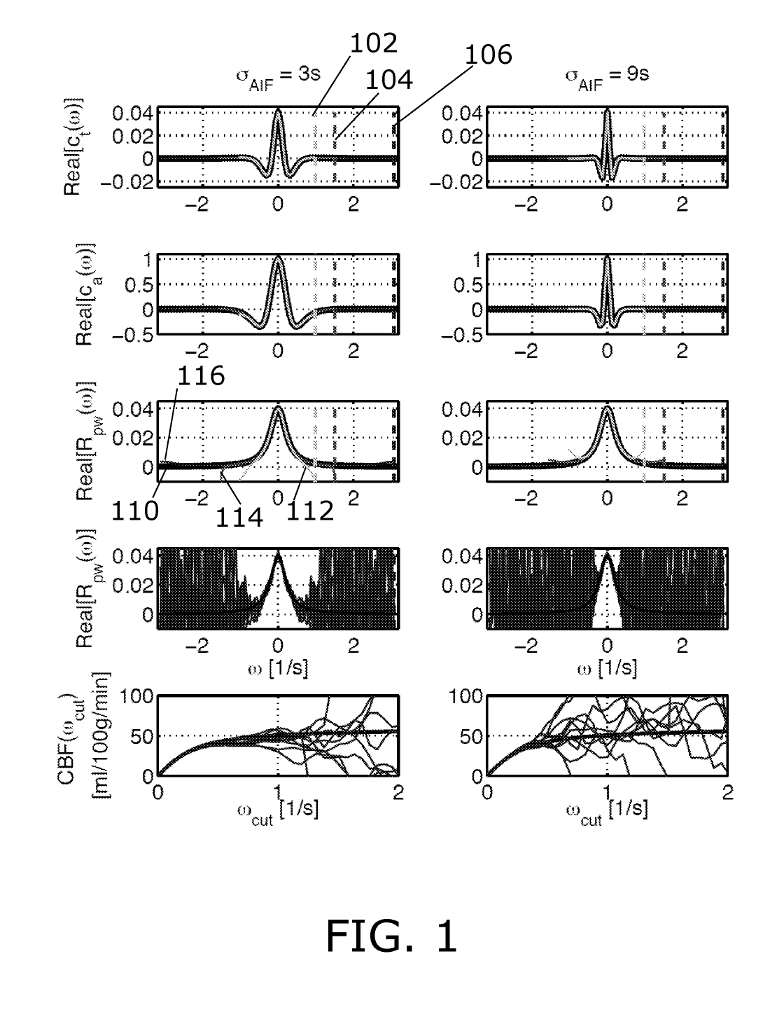

FIG. 1 shows an illustration of deconvolution in the Fourier domain (equation 1). From top to bottom: Noiseless spectra of the tissue concentration curve, the AIF, the resulting residue function, R_pw, and the effect of noise. The two columns are for two different AIF widths, sigma_AIF. The black curves, shown in a subfigure with reference sign 110, are the curves with high sampling rate (the ground truth) and the dark grey, shown in a subfigure with reference sign 116, is for TR=1 s, the medium grey, shown in a subfigure with reference sign 114, for TR=2 s and the light grey, shown in a subfigure with reference sign 112, for TR=3 s. The vertical dashed lines 102, 104, 106 show the corresponding maximal sampled frequency. The second last panel shows 10 noise realizations for TR=1 and SNR=40 superimposed on the true spectrum, and the last panel shows the corresponding accumulated spectra. The noiseless AIF for high frequencies is calculated as division of two small values with minor errors due to undersampling. Noise destroys any information in such regions. The information loss is especially high for AIF with narrow spectrum (right), which corresponds to a wide AIF in the time domain.

An optimization of the regularization used in combination with a deconvolution procedure is presented. Application of regularization is necessary when estimating R_pw(t) in the presence of noise. The strength of regularization is determined by a parameter called the regularization level which typically is optimized for its specific use in a balance between accuracy (systematic bias) and precision (random error) of the final result. Previous optimization procedures optimize the regularization level to accuracy by comparing the estimated CBFs from different regularization levels to their true counter parts across a realistic range of CBFs.

We propose to use FT and to select the optimal regularization level directly from the spectrum of R_pw (t). The optimal cut-off frequency, omega_opt, (regularization frequency) is operationally defined as the frequency above which the spectra are dominated by noise (FIG. 1). The spectrum of R_pw (t) is given as

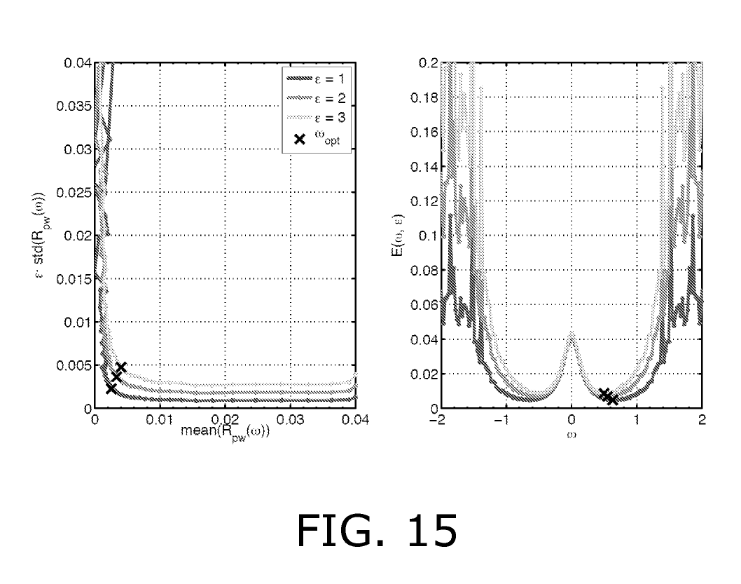

R_{—}pw(omega)=c_{—}t(omega)/c_{—}a(omega) (equation 1)

where c_t(omega) and c_a(omega) are the spectra of the tissue curve and the AIF respectively, i.e., a first concentration curve (c_t) representing a convolution of a second input concentration curve (c_a) convolved with a residue function (R). This cut-off can be thought of as the point where the trade off between the mean of R_pw (omega) (systematic bias) and standard deviation of R_pw(omega) (random error due to noise) shifts in favour of the standard deviation. This corresponds to the point of maximal curvature in the graph of mean(R_pw(omega)) versus epsilon*std(R_pw(omega)) (FIG. 15). In a practical setting, due to noise, this maximal curvature approach to the identification of the cut-off is unreliable, even with the use of smoothing filter. While the shape of the true residue function is unknown, we chose to optimize the cut-off search for exponential-like residue functions. Its spectrum is a Lorentzian whose real part is a smooth, monotonically decreasing function. This encourages us to define the optimal cut-off as the minimum of the error curve, E(omega,epsilon):

E(omega,epsilon)=mean(R_{—}pw(omega))+epsilon*std(R_{—}pw(omega) (equation 2)

We used epsilon=1 in order to maintain spectral information (as epsilon increases, the optimal frequency decreases). We used a 5 point smoothing filter before minimizing E(omega, epsilon). The minimum of E(omega, epsilon) occurs where the measured spectrum of the residue function deviates from the true spectrum, readily identifiable in the spectrum (FIG. 1, fourth row showing Real(R_pw(omega))). Our analysis showed that this point corresponds well to the trade off point defined above (FIG. 15), while being far more stable to implement. We expect the standard deviation of R_pw(omega) to increase strongly when the amplitude of the spectra of the concentration curves are below the noise level (FIG. 1) and this happens for different frequencies depending on the shape of the concentration spectra. We therefore expect omega_opt to depend on the SNR, TR and the width of c_a(omega) and c_t(omega). The dependence on the widths of the AIF, sigma_AIF, is illustrated in FIG. 1. The optimal cut-off frequency, omega_opt, (regularization frequency) is operationally frequency above which the spectra are dominated by noise (FIG. 1).

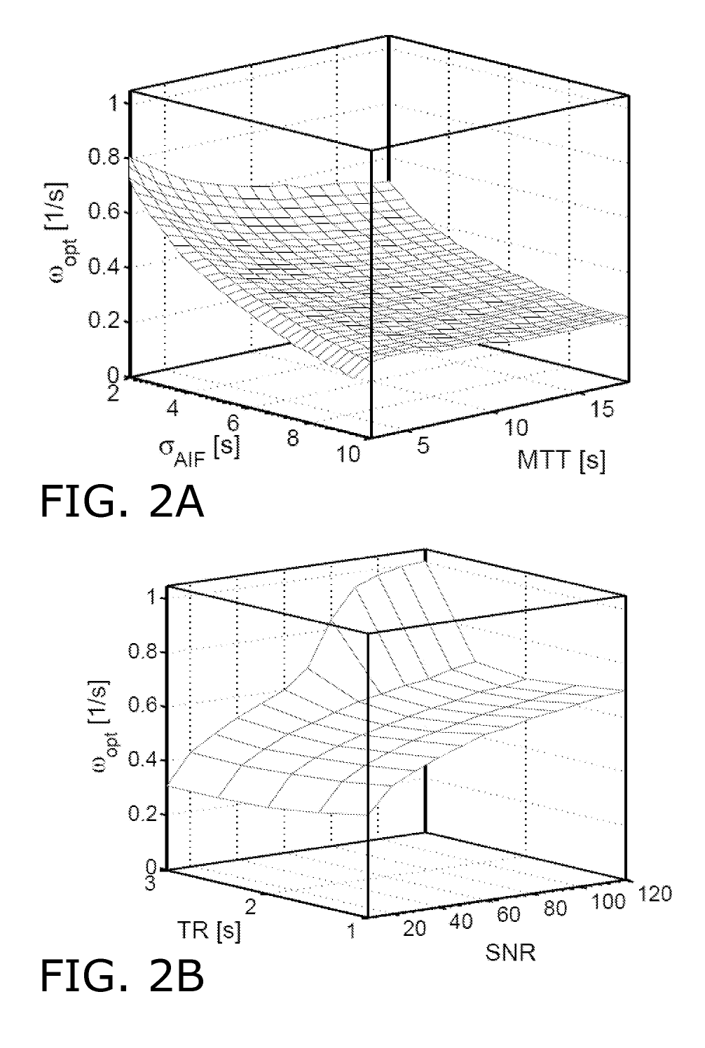

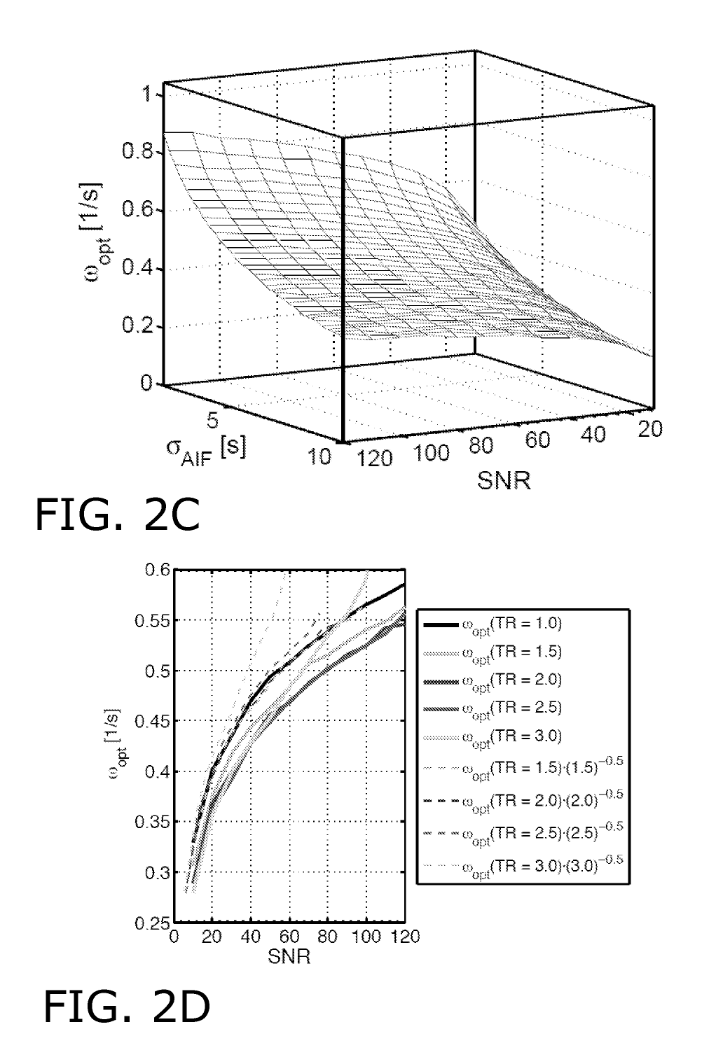

FIGS. 2A-C show a look up table. Three cross sections of the look-up table of omega_opt for the parameters TR=1 s, t_length=120 s, SNR=40 and sigma_AIF=3 s and MTT=6 s are shown. The cut-off frequency, omega_opt for optimal regularization of FT deconvolution for different values of sigma_AIF, MTT, TR and SNR is defined according to equation 2. The results can be stored in a look-up table. From the different cross sections, it is evident that omega_opt depends strongly on SNR, MTT and sigma_AIF. The relative change in omega_opt going from sigma_AIF=2 s to sigma_AIF=4 s is ˜44% and for SNR from 30 to 50 is ˜12% for MTT going from 4 s to 6 s is ˜9%. A dependence on t_length and the number of AIF averages were not observable except in the cases where t_length was not long enough to cover the full bolus passage due to wide AIF and/or long MTT. Note that the optimal frequency is subjected to a scaling. A simultaneous increase in all time parameters (TR, sigma_AIF, MTT) results in a proportional decrease in omega_opt. This can be used to reduce the dimensionality of the look-up table by one. We observe that narrow AIFs display a stronger MTT dependence of omega_opt. This is expected due to the wider spectrum of the AIF, see FIG. 2a, which allows the tissue spectrum to define the frequency at which noise dominates; omega_opt increases as MTT decreases (wider spectrum). In contrast, the width of the tissue spectrum (given by the MTT and sigma_AIF) is less important for very wide AIFs which gives a very narrow spectrum and thus not many points in the important part of the spectrum to be used in the perfusion calculation. Because MTT is not known a priori, we used MTT=6 s, well within the typical MTT range, in subsequent use of the look-up table. Note that omega_opt does not display a strong dependence of TR except in the case TR>2.5 s where insufficient sampling leads to strong aliasing artefacts causing the strong ‘bend’ seen in the look-up table.

FIG. 2D shows that given a sufficient sampling of the concentration curves, the relation between TR and SNR behaves according to the principles of oversampling

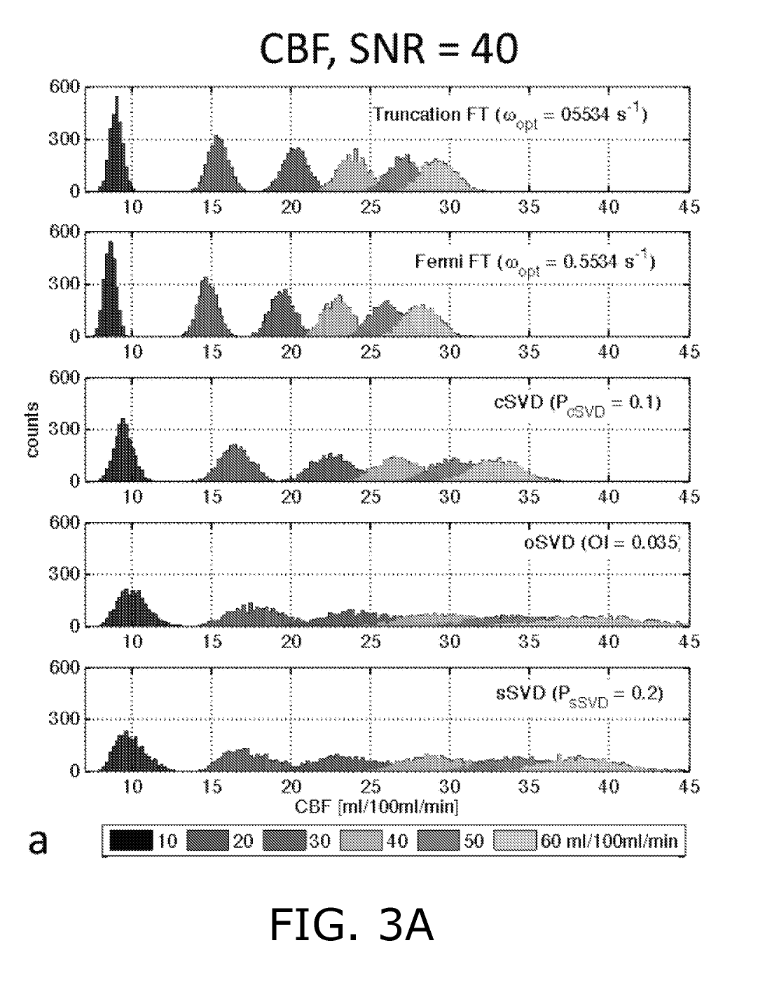

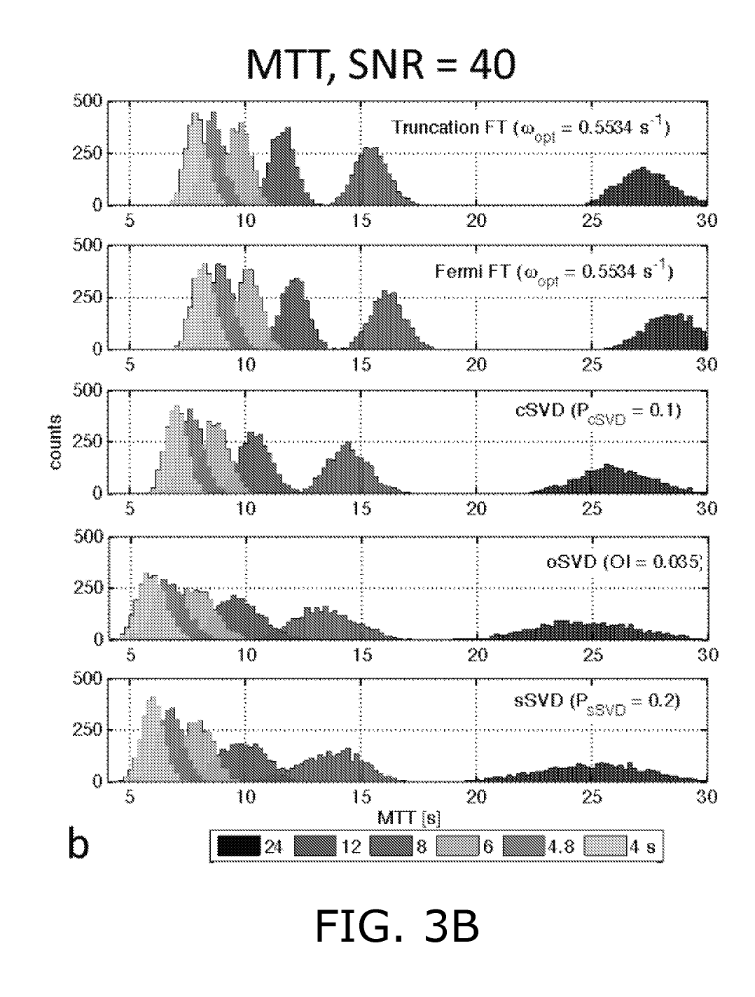

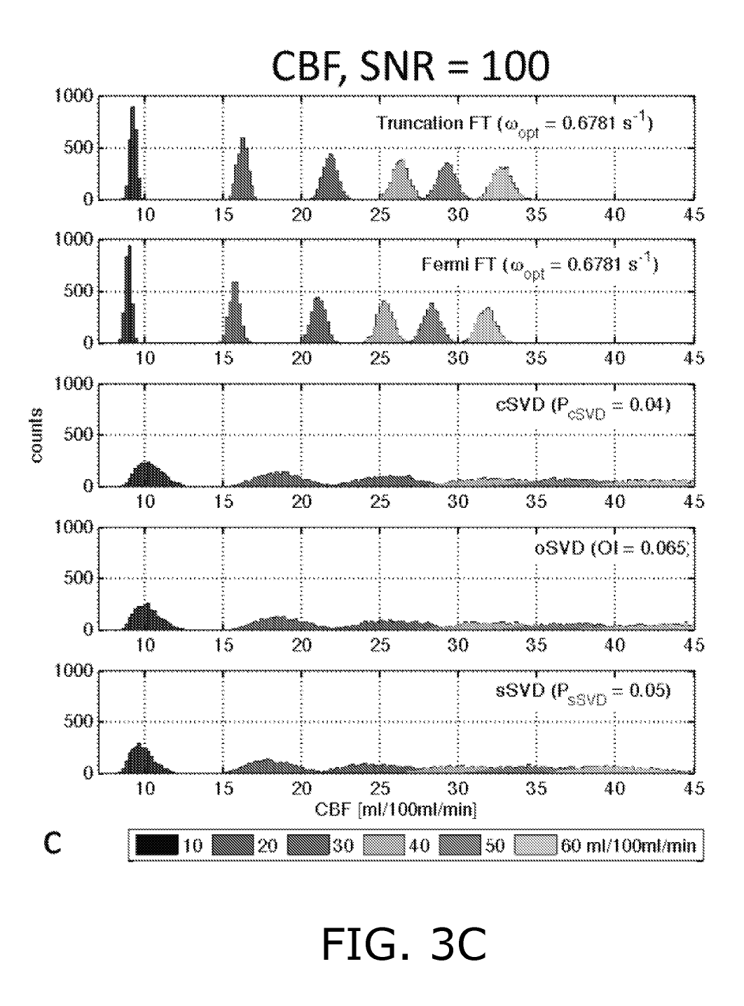

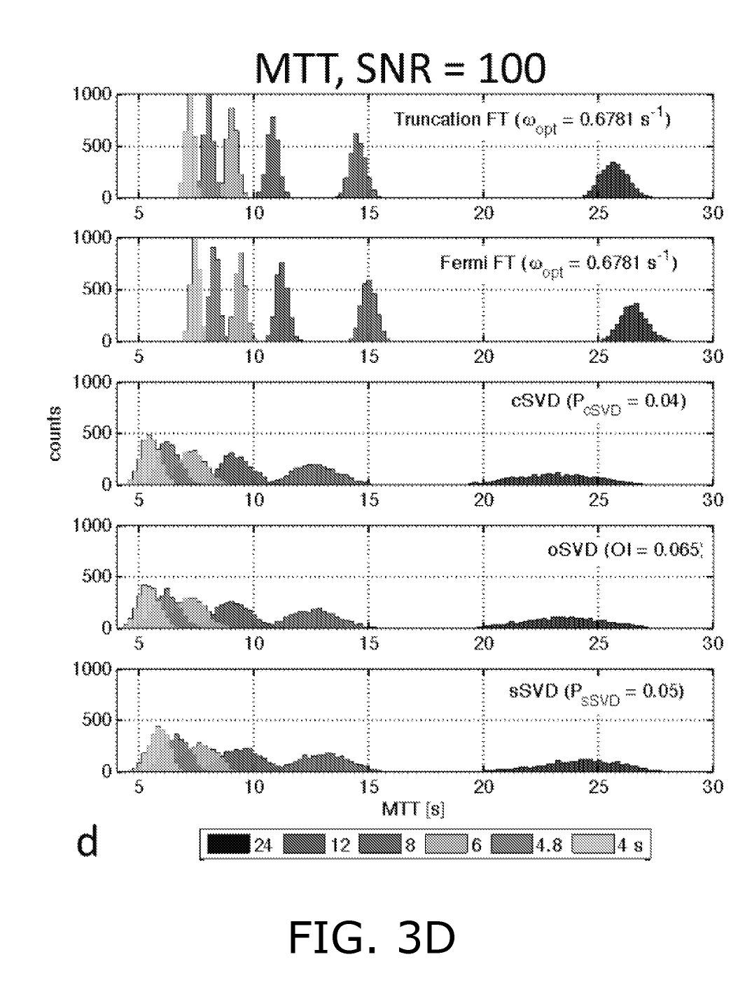

FIGS. 3A-D shows CBF and MTT discrimination for CBV=0.04 using five different approaches on simulation data. PsSVD and PcSVD are the regularization levels in sSVD and cSVD respectively and OI is the oscillation index used in oSVD. Each figure shows the discrimination for five different approaches on the same data set (2500 noise realizations). AIF is the mean of five noise realizations. FIG. 3A and FIG. 3B show CBF and MTT discrimination, respectively, for SNR=40, and FIG. 3C and FIG. 3D show CBF and MTT discrimination, respectively, for SNR=100.

In FIG. 3, the CBF and MTT discrimination among different regularization levels and methods are compared for SNR=40 and SNR=100 using simulated data with TR=1 s, CBV=4% and an exponential residue function. We compare the derived CBFs (termed CBF_app) and MTTs (termed MTTapp) using both the truncation and Fermi filter with the regularization level taken from FIG. 2A-C, to the estimates obtained from cSVD, sSVD and oSVD using the optimal regularization parameters by Wu et al. (Magn Reson Med 2003; 50(1):164-174) defined for TR=1 s and SNR=20 and SNR=100 respectively. The AIF (sigma_AIF=3 s) was an average of 5 noise realizations. We found that the proposed regularization level markedly improved the discrimination between different CBFs and MTTs as compared to the commonly used regularization levels (FIG. 3).

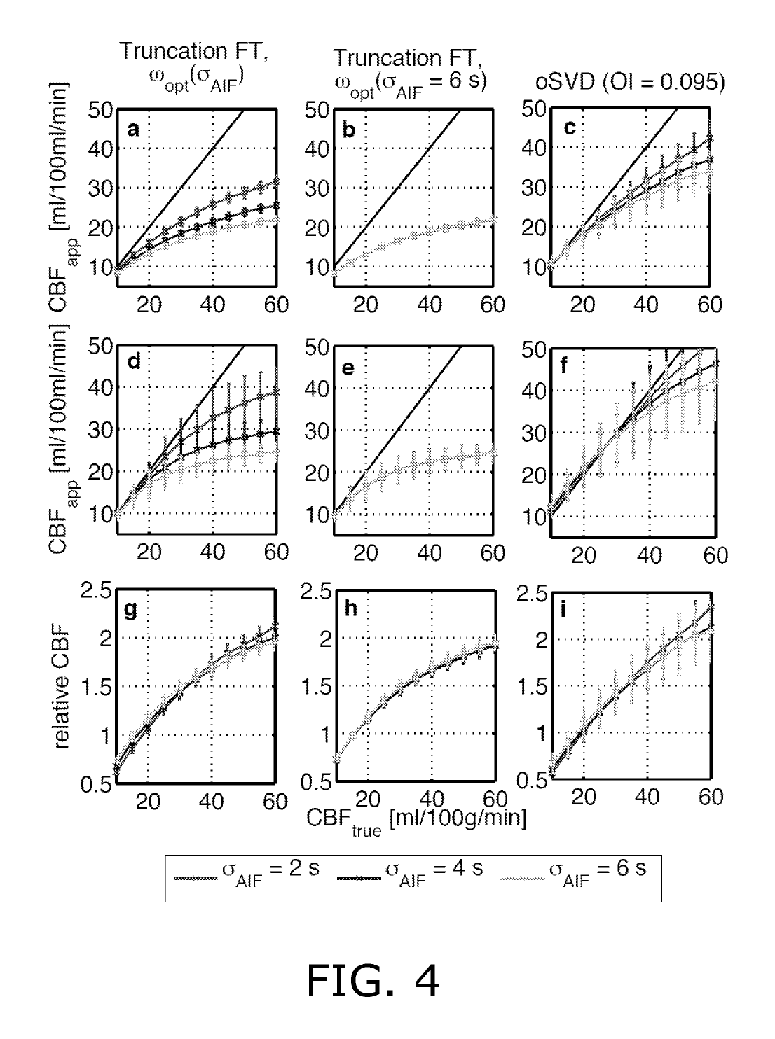

FIG. 4 shows apparent CBFs in group studies as a function of the true CBF for different regularization schemes (columns). Figures in the first row uses an exponential R(t) whereas for the second row averages over the three R(t) types with equal weight. The errorbars include averaging over different t0 in the AIF and different noise realizations with SNR=40. The three greys represent three different sigma_AIF. Comparing e.g. (a) and (c)+(d) clearly demonstrates the tradeoff between accuracy and precision. (g)-(h) Apparent normalized CBFs in group studies as a function of the true CBF for different regularization schemes (columns).

Selecting the regularization level from FIGS. 2A-C based on the patient specific sigma_AIF, TR and SNR leads to optimized precision in the perfusion estimates on an intra-subject basis. Both intra- and inter-subject reliability are important in patient cohort studies. Applying a patient specific regularization level inevitable leads to different accuracy (systematic bias) in the perfusion estimates for the different patients due to the different AIF widths. This difference in accuracy is illustrated in figure FIG. 4A presenting the CBF profile determined from an exponential residue function using the optimized regularization from FIGS. 2A-C. In FIG. 4C, the corresponding CBF profiles are shown for oSVD using the regularization level suggested by Wu et al. (Magn Reson Med 2003; 50(1):164-174) which were optimized for sigma_AIF=3 s. From the figures it is evident, that the higher accuracy is obtained on behalf of the precision for oSVD. In FIG. 4B, the regularization level is selected according to the widest AIF (sigma_AIF=6 s) which is the most restrictive (omega_opt is smallest). We observe that the identical regularization level leads to equal accuracy across AIF widths and thereby leading to comparable CBF estimates. The second row in FIG. 4 shows corresponding CBF profiles (CBF_app versus CBFtrue) as in the top row averaged over three residue functions with equal weight. The three residue functions are the exponential, the boxcar and the triangular residue function. The third row shows the data from first row relative to simulated normal WM (CBF=22 ml/100 ml/min and CBV=2.5%). Generally we find that the proposed regularization level led to good precision across different sigma_AIF in contrast to oSVD (FIG. 3.6). Averaging the derived CBFs over three different R(t) shapes decreased the precision for both truncation FT and oSVD, but most for oSVD. Normalizing the CBFs on normal WM leads to more comparable CBF profiles, however, the normalization does not completely eliminate the difference in the CBF profiles when using different regularization levels.

Thus, the optimized regularization level leads to better precision in the perfusion estimates as compared to the existing regularization levels, leading to a better discrimination of low CBFs. Moreover, using identical regularization levels determined from one of the widest AIFs in a patient cohort will lead to comparable perfusion estimates across all patients with high precision.

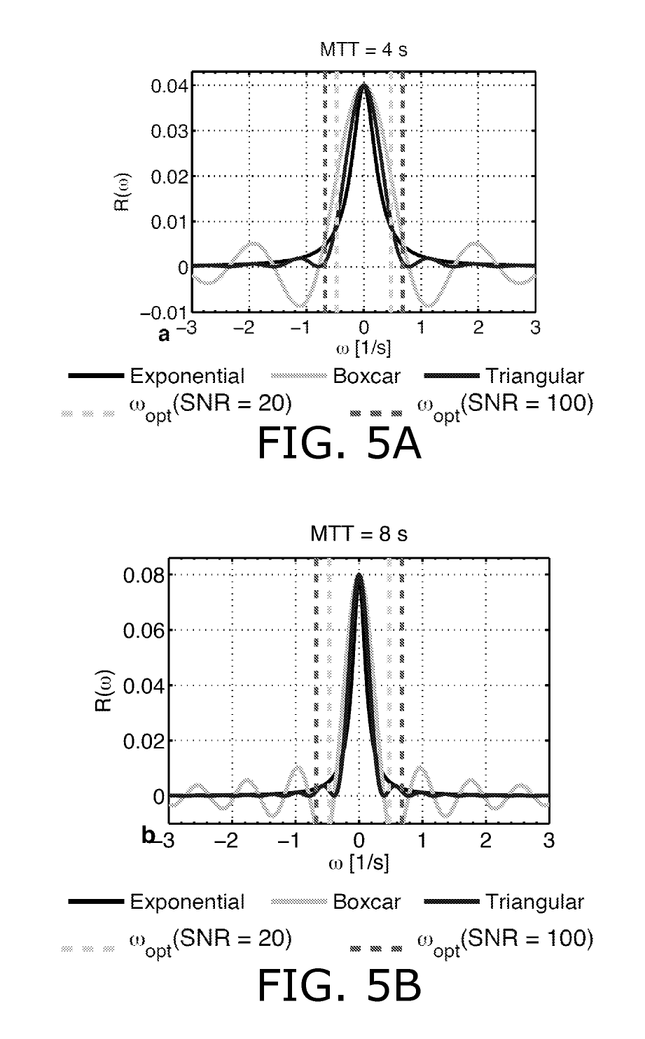

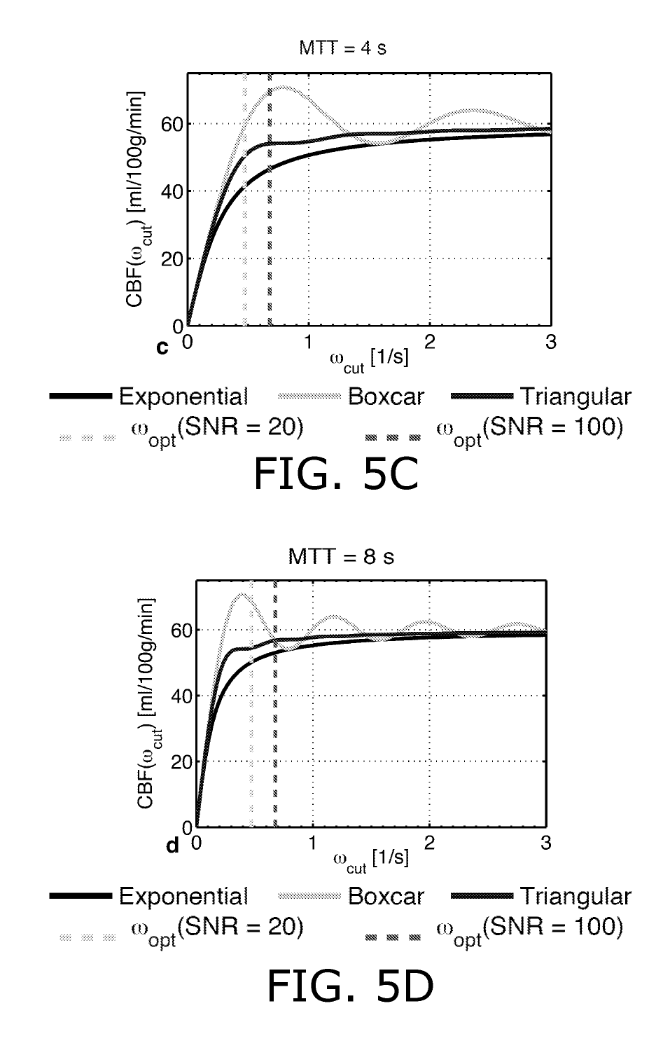

FIGS. 5A-B show the real parts of the spectra of three residue functions. The legend is seen below each figure.

FIGS. 5C-D show the accumulated spectra of three residue functions, calculated according to equation 4. The dashed lines indicate typical regularization levels from the proposed optimization. In FIG. 5A and FIG. 5C MTT=4 s and in FIG. 5B and FIG. 5D MTT=8 s. Note that the relevant range of frequencies is given by TR: omega_max=π/TR. Thus TR=1.5 s yields omega_max˜2 ŝ(−1). The noise typically dominates before omega_max is reached (FIG. 1).

The proposed optimization criterion differs from existing criteria by selecting the regularization level directly from the spectrum of Rpw, as opposed to selecting the regularization level based on derived parameters such as CBF and MTT. Previous work in the field defined the optimal regularization level as the level which minimized the total error, E_t, over different noise realizations and three residue models, where E_t≡1/NCBF SUM|CBF_true−CBF_app| and NCBF is the number of simulated flow values. Due to the inherent trend of underestimating the CBF this unavoidably leads to a regularization level which provides CBF estimates associated with a considerable standard deviation, in order to assure accuracy. That is, when minimizing |CBF_true−CBF_app|, more of the spectrum (higher frequencies) must be included in the CBF estimate (and thereby also more noise). This can be seen clearly from the large error bars on the cSVD-, sSVD and oSVD-based perfusion estimates presented in FIG. 3 and FIG. 4. With our approach the accuracy is compromised in order to gain better precision, as seen in the same figures. We present in this work a comprehensive look-up table of the optimal regularization frequency cut off, omega_opt, covering several TRs and SNRs thereby extending earlier work. The optimization was limited to constant CNR according to Wu et al. (Magn Reson Med 2003; 50(1):164-174). Moreover, we introduce the width of the AIF as a new parameter, sigma_AIF, in the optimization that turns out to have a great impact on the optimal regularization level (FIG. 2A). The impact of sigma_AIF on the perfusion estimates has already been investigated in the context of injection speed, but it has never been included in the optimization of the regularization level. We varied sigma_AIF in the simulations by changing the parameter beta in the expression of the gamma variate function

c_{—}a(t)=0, if t=<t_{—}0

c_{—}a(t)=(K*(t−t_{—}0)̂alpha)*exp(−(t−t_{—}0)/beta), if t>t_{—}0 (equation 3)

which we use to model the true AIF, keeping alpha constant. This procedure clearly limits the shape of the AIFs investigated. It would be interesting to extend the work with different shapes of the AIF by changing both beta and alpha keeping sigma_AIF or FWHM constant at different values. When applying the proposed regularization level using the look-up table on real data, it would seem natural to include gamma variate fitting of the AIF in the post-processing in order to determine the shape more precisely (getting alpha and beta from the fit). We, however, speculate that this approach potentially would introduce more uncertainties to the estimates especially at low SNRs due to its challenging nature, and suggest that FWHM is a more robust parameter to use in the determination of a regularization level. In relation to AIF shapes, we moreover neglect the second pass of the bolus in the optimization. In experimental data, the first bolus could be extracted using methods such as those introduced previously in the art. In order to further investigate the influence of different AIF shapes in simulations, a simulation of a full circulation using realistic parameters could be used. In contrast to the optimization approach by Wu and coworkers (Magn Reson Med 2003; 50(1):164-174), we do not optimize over different residue function shapes (apart from varying MTT). We limited the optimization to the exponential residue model, which we expect to be the most realistic shape as compared to boxcar and triangular models. Although Wu and coworkers optimized over three residue models they present CBF estimates that differ significantly when derived from different underlying residue functions. This effect is caused by the differing shapes of the spectra leading to different convergences towards CBFtrue as a function of omega (FIGS. 5A-B). This can be observed clearly from the accumulated spectrum, defined by F(omega_c) which is equal to 2 R_pw(omega)/2/pi integrated with respect to omega from −omega_c to omega_c.

$$F ( {ω}_{c} ) = 2 {\int }_{- {ω}_{c}}^{{ω}_{c}} {R}_{pw} ( ω ) \frac{d ω}{2 π} \qquad ( equation 4 )$$

where omega_c is the cut-off frequency in the spectrum (which for truncation filters is equal to omega_opt). The accumulated spectrum is shown in FIGS. 5C-D for two different MTTs. The factor of two in front of the integral arises from the inherent periodic property of FT leading to interpolation at discontinuities, such as at t=0, where R_pw(t) theoretically increases from zero to CBF instantaneously causing the value at t=0 to be CBFtrue/2 after FT. It is also evident that the convergence depends on MTTtrue which introduce a bias in CBF_app and MTT_app across voxels with different underlying MTTtrue (compare FIG. 5A and FIG. 5B).

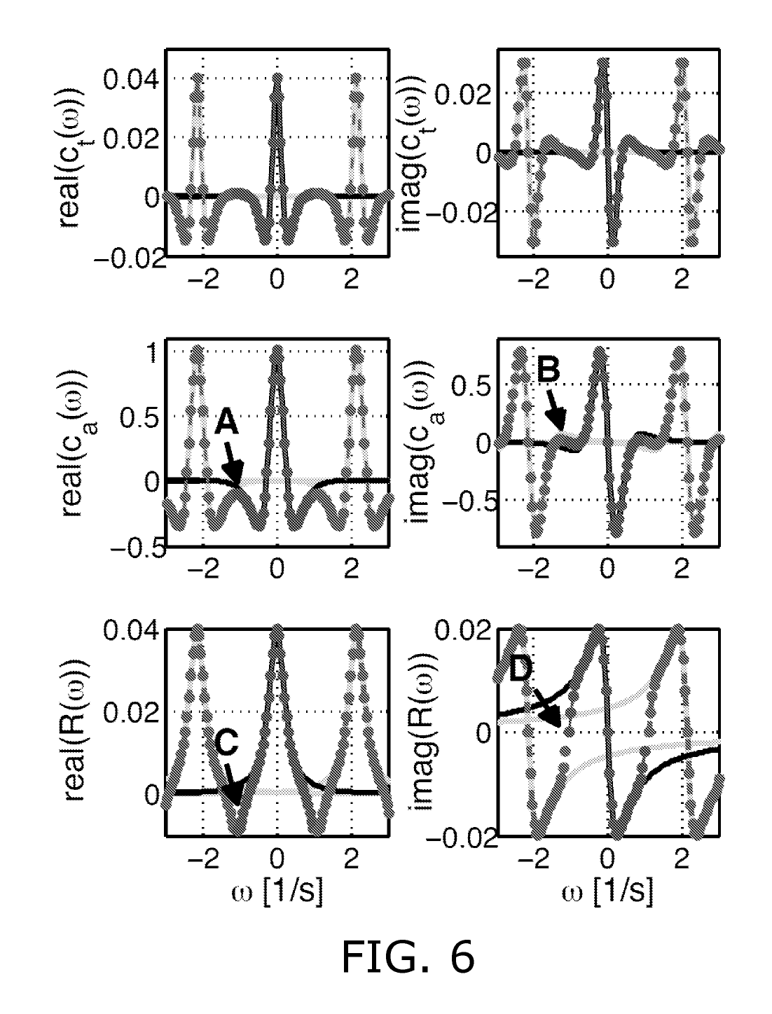

FIG. 6 shows the real and imaginary part of the spectra c_t(omega), c_a(omega) and R(omega) for TR=3 s, sigma_AIF=3 s and MTT=6 s. The red curves are the downsampled spectrum, the black curve is the true spectrum and the grey curves are the true spectrum shifted 2π/TR in order to illustrate the expected aliasing. The black arrows shows where the effect of aliasing is observed.

The differences in CBF_app due to different R(t) shapes and MTTs are reduced when using an AIF which is narrow in the time domain. The corresponding wide spectrum of the AIF leaves more of the spectrum free from noise dominance (FIG. 1). Too narrow AIFs, however, will be undersampled at the experimentally achievable TRs. The error depends on the actual sampling of the AIF time course. Inter-subject variations in the AIF timing, although identical underlying AIF shape, give rise to an error that appears random across subjects. Undersampling of the AIF also leads to aliasing. Aliasing occurs when the measured signal has spectral information at frequencies larger than the maximal frequency measured, omega_max=n/TR. This is most likely to occur for narrow concentration curves (wide spectra). In FIG. 6, this aliasing effect caused by insufficient sampling is illustrated in the severe case for TR=3 s, sigma_AIF=3 s and MTT=4 s. The aliasing of c_t(omega) is not visible, but the aliasing in c_a(omega) is observed at the arrow labeled ‘A’. The imaginary part (which also contribute to the real part of R_pw(omega)) must—by the properties of the FT—maintain periodicity, causing inaccuracy at the zero-crossing at omega_max—see the arrow ‘B’ in FIG. 6. R(omega) is affected both in the real and imaginary part, as indicated in the f figure with arrows ‘C’ and ‘D’. In general, aliasing depends closely on data sampling, AIF and MTT. The effect of aliasing is evident from the omega_opt-look-up table when the aliasing overlaps the minimum in E(omega, epsilon), causing our minimum search to fail leading to the strong ‘bend’ in the look-up table, FIG. 2C, towards TR=3 s and high SNR. This can be understood from the spectrum seen in the lower left panel of FIG. 6, where the spectrum is seen to continue decreasing as a function of frequency (letter C in FIG. 6) due to aliasing and thereby no minimum can be found. Aliasing has most impact on high frequency components and therefore we include more aliasing effects as the SNR increases due to the increasing amount of high frequency components above noise level. Summarizing the above, the main type of errors appearing in CBF_app after deconvolution are (i) systematic errors caused by different underlying R(t) shapes and widths (MTT) (ii) systematic errors caused by insufficient sampling of the AIF. The main task in the deconvolution is to suppress noise in the spectrum of the AIF, even if averaging in practical implementations reduces it. The shape of the AIF can be affected by the injection rate, which raises the question about its optimal width. This width should insure a good sampling, but not exceed the expected width of R_pw(t). There is little room for selecting this value given realistic measurement parameters. The optimal sigma_AIF should be close to the MTT, which is defined by the shape of the expected R(t). In conclusion, our results support the general recommendation of low TR and narrow, but sufficiently sampled, AIF. The AIF is sufficiently sampled when sigma_AIF>TR which corresponds to TR<FWHM/2.1 in terms of the FWHM of the AIFs.

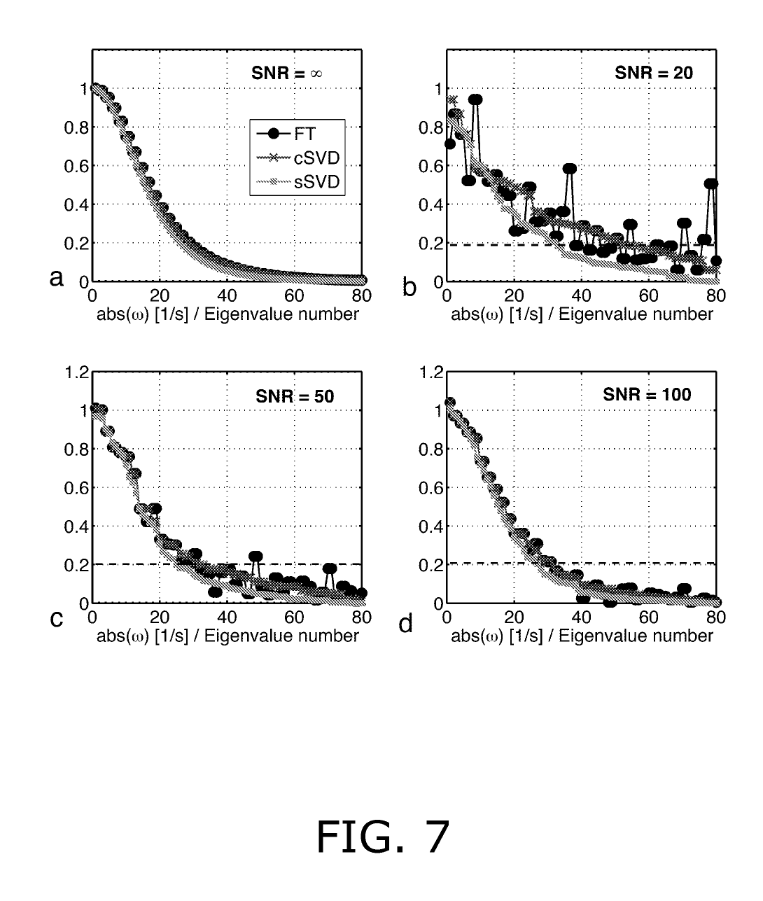

FIG. 7 shows four plots showing the eigenvalues as a function of matrix index number in the eigenvalue matrix from the cSVD compared to |c_a(omega)| as a function of |omega| for four different SNRs for a single noise realization. The dashed line shows the 20% threshold level for cSVD. Furthermore, the FIG. 20 shows the corresponding eigenvalues for sSVD.

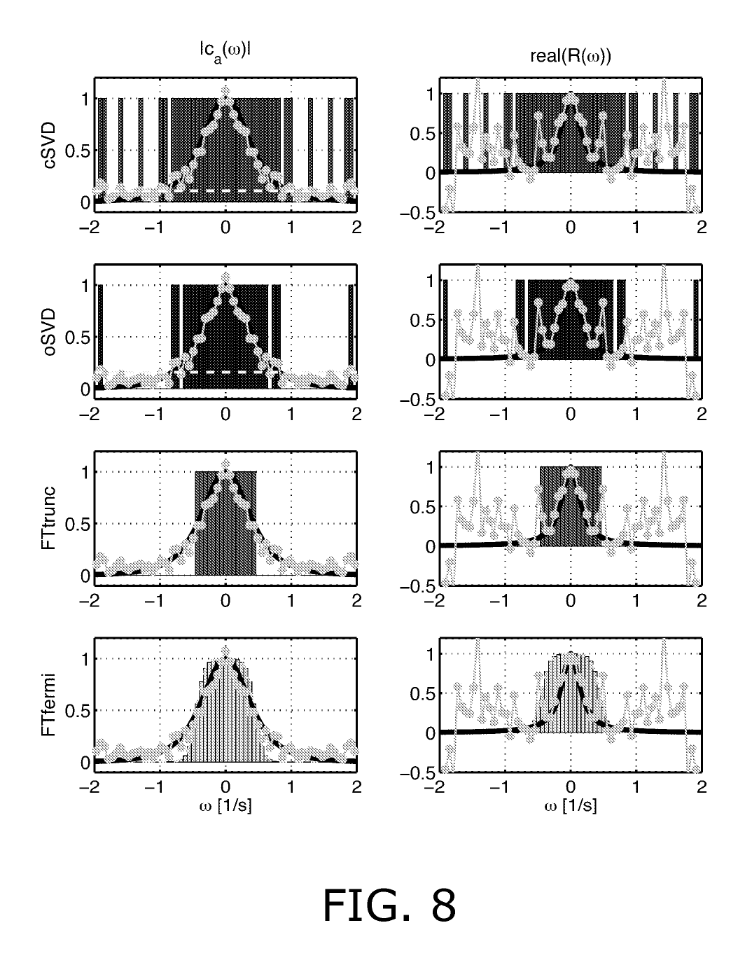

FIG. 8 shows the regularization filter for four methods. Left column: The AIF spectrum. Right column: R_pw(omega). Black solid lines correspond to noise free spectra. The grey curves correspond to SNR=20. The bar-plots are the regularization filters to be multiplied on the showed spectra. The yellow dashed lines are the threshold used in the cSVD and oSVD from Wu et al. (Magn Reson Med 2003; 50(1):164-174). Parameters of the simulation: TR=1.5 s, t_length=51 s, MTT=6 s, sigma_AIF=3 s and zero filling to double length is used.

The cSVD procedure is described by Wu et al. (Magn Reson Med 2003; 50(1):164-174) and the obtained eigenvalues of the AIF is equal to the Fourier components, |c_a(omega)|, obtained from FT, up to a permutation due to the inherent property of SVD to sort the eigenvalues in descending order. In the noise free situation eigenvalues of the cSVD are ordered according to increasing frequency because the AIF (modeled as a gamma variate) has a monotonically decreasing spectrum (FIG. 7A). Note that the eigenvalues appear in frequency pairs (±omega), except for the zero frequency component, this is not the case for the sSVD eigenvalues (FIG. 7). The difference between the two representations of the AIF derived from FT and cSVD appears when noise is added (FIG. 7B-D). Especially for low SNR, the one-to-one correspondence between eigenvalue position and frequency is almost completely lost. This has a direct impact on how the low pass filters work in frequency space for FT and cSVD as illustrated in FIG. 8. In the first column of FIG. 8, |c_a(omega)| is shown as a function of omega in a noise free case (black solid line) and in the presence of noise (in grey). For cSVD and oSVD the regularization levels are defined as percentages P cSVD and P oSVD, and the eigenvalues that fall below the limit of this percentage multiplied by max(|c_a(omega)|) are set to zero. Where P cSVD is a global threshold, P oSVD is determined from an oscillation index, OI as described by Wu et al. (Magn Reson Med 2003; 50(1):164-174) and thereby potentially can differ between different noise realizations of the same underlying spectrum. The regularization level defined by P cSVD and P oSVD are shown in the figure as light grey dashed lines. Where the truncation levels in cSVD and oSVD are represented as horizontal lines, the truncation frequency, omega_opt, is by nature a vertical line. This difference is the key to why the frequency representation of these two truncation filters differ (FIG. 8). The inclusion of high frequency components in the cSVD and oSVD truncation filters occur when components of the noise affected spectrum of the AIF is above the truncation level, and this happens, as indicated in FIG. 7, mostly for low SNRs. In the second column of FIG. 8, the residue spectra are shown for comparison. This inclusion of high frequency noise is completely avoided by using FT instead of cSVD based methods and moreover gives more intuitive filter representations. We can only speculate, that similar effects occur for the sSVD truncation filter. Due to the equivalence between cSVD and FT it is possible to make an FT based cSVD and oSVD implementation which benefit from the enhanced computational speed of FT. Comparing the time used by the oSVD implementation used in the clinic at our centre and an FT based oSVD, called oFT, for processing a full slice (128×128) with AIF length of 32 time points, more than a factor of two in calculation speed was obtained. There exists other deconvolution approaches than the FT based and SVD based methods discussed above. We speculate that only fitting-methods have the potential of acquiring more accurate perfusion estimates due to the possibility of extrapolating the spectrum into higher frequencies which are covered by noise (the high frequency information is necessary for the reproduction of the sharp edge at t=0 for the residue function). The fitting methods, however, often are more computational demanding and their perfusion estimates are typically based on initial assumptions of the residue model. Moreover, the fitting methods also struggle with low precision of CBF_app.

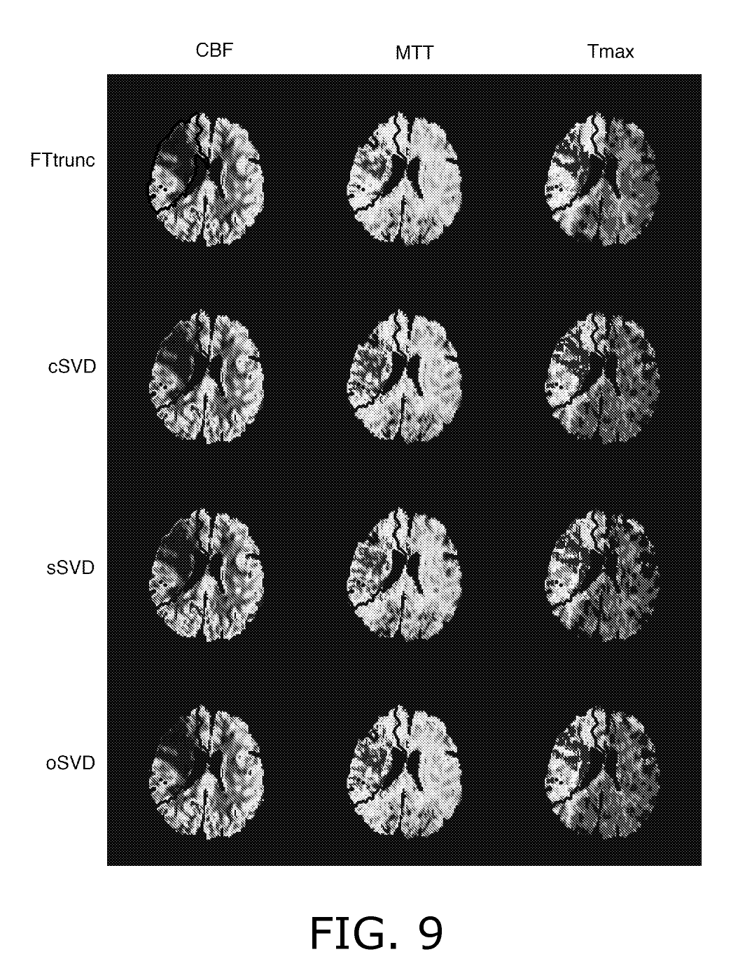

FIG. 9 shows patient data (patient A) acquired using T_E=37 ms, TR=1.5 s. FWHM=8.8 s. CBF and MTT are shown as normalized values (by division of the mean of a region of interest (ROI) on the contra lateral side of the infarct). The final infarct size is outlined in black.

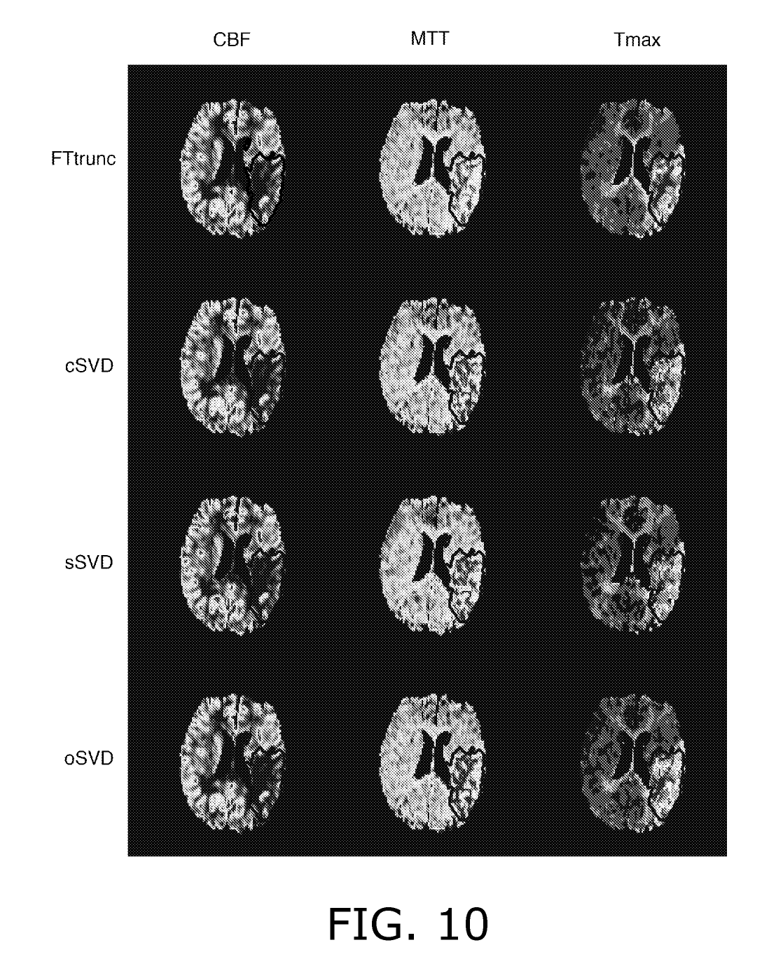

FIG. 10 shows patient data (patient B) acquired using T_E=37 ms, TR=1.5 s. FWHM=8.8 s. CBF and MTT are shown as normalized values (by division of the mean of a region of interest (ROI) on the contra lateral side of the infarct). The final infarct size is outlined with the black line.

The proposed regularization levels from the omega_opt-look-up table (FIG. 2A-C) generally lead to stronger regularization as compared to those previously used as confirmed by the example in FIG. 8. The stronger regularization ensures a higher precision at the expense of accuracy. This was confirmed by the simulations presented in FIGS. 3-4. Generally, the regularization level should provide perfusion estimates with high enough accuracy and good enough precision to ensure a good discrimination. In the section below, the performance of the different regularization levels are discussed in relation to both simulation data as well as patient data. Thereafter, a brief discussion of global and voxel-wise regularization is presented.

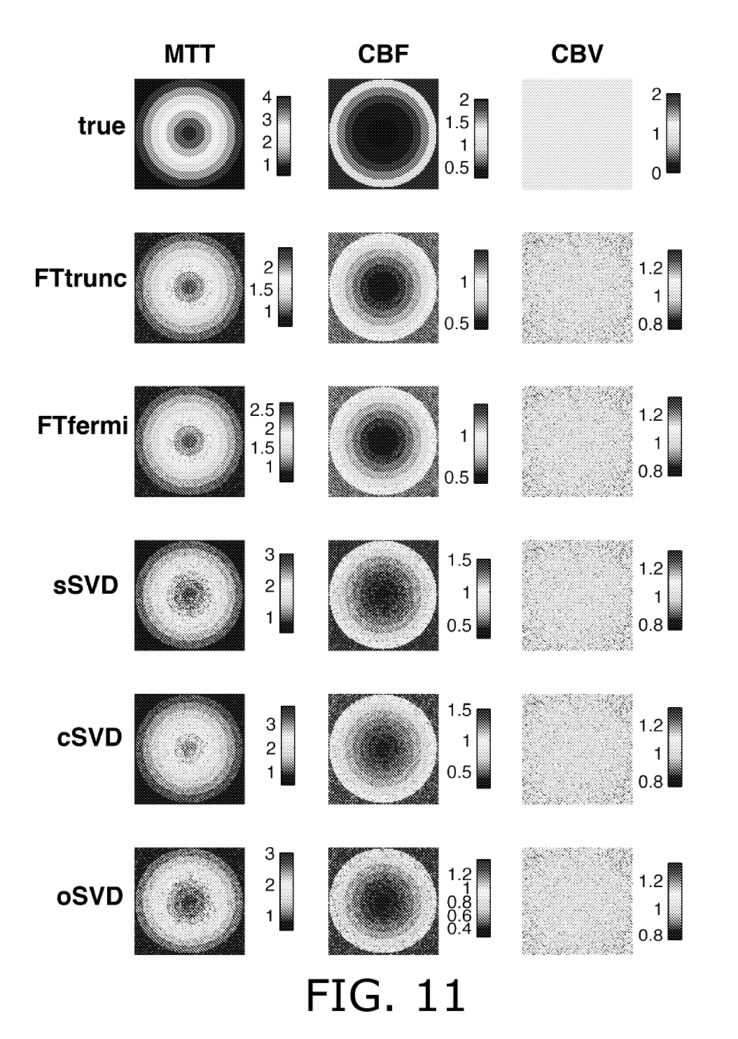

The performance of the different regularization methods is investigated in both patient data (for two stroke patients named A (FIG. 9) and B (FIG. 10) and simulation data (FIG. 11). The patient data is presented for the truncation filter methods (FIG. 9). Because the true underlying perfusion parameters are not known, we outlined the final infarct in black. The perfusion estimates are shown relative to the contra-lateral side (normalization was performed by dividing all voxels with the mean value of a ROI placed in a seemingly homogeneous ROI at the contra-lateral side). The simulation data is presented as ‘circle-maps’ which represent an image having increasing MTT true towards the centre of a circle (FIG. 11) simulating an infarcted area. These maps allow for visual inspection because the true underlying perfusion values are known. The ‘circlemaps’ (FIG. 11) are produced for the five different approaches (FTtrunc, FTfermi, sSVD, cSVD and oSVD) and maps of MTT, CBF, CBV, T_max and T̂interp_max are presented. The latter parameter is an FT-interpolated estimate of T_max: We zeropad R_pw(omega) by a factor 9 and thereby get a R_pw(t) sampled with TR/9 yielding a more smooth T_max estimate. This was performed for all methods (using that the cSVD based methods can be implemented using FT due to the equivalence.) except sSVD (no FT equivalence.) where the 3 highest values of R pw (t) are fitted by a parabola, and the maximum of the parabola corresponds to T̂interp_max. The perfusion parameters are normalized to simulated normal GM with CBF=60 ml/100 g/min, CBV=4%, MTT=4 s, t 0=0 s. The regularization levels are taken from Wu et al. (Magn Reson Med 2003; 50(1):164-174) and a method according to an embodiment of the present invention. For the patient data (FIG. 9), the overall picture is that all the different approaches find similar infarct areas. The FTtrunc CBF image appears to have somewhat sharper edges (better contrast) as compared to the other approaches, and both the FTtrunc MTT and T_max image seem less noisy. The AIF has FWHM=8.8 s.

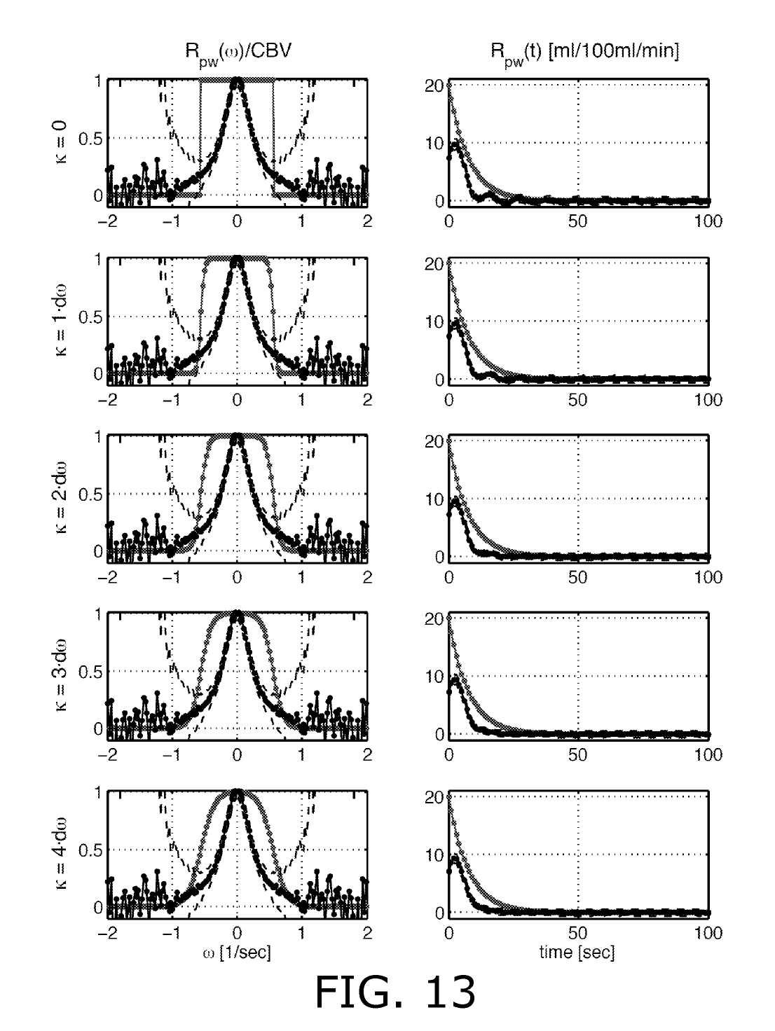

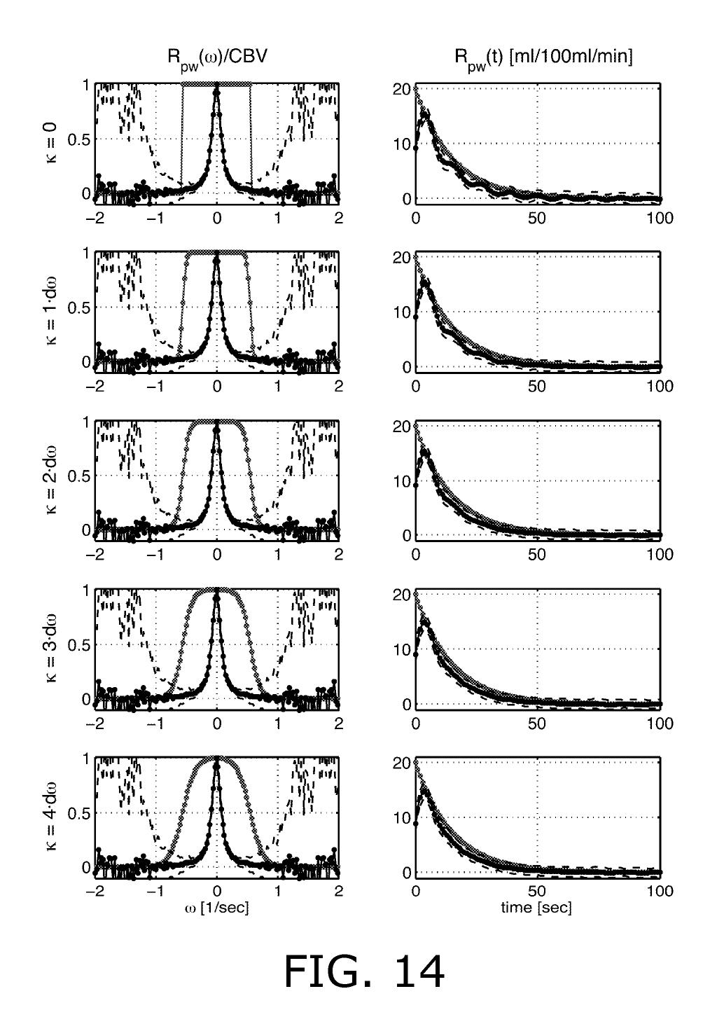

Because the underlying truth is not known for the patient data, it is safer to discuss the performance in simulation data. In the simulation data (FIG. 11), FTtrunc and FTfermi generally outperform the three other methods regarding contrast for both MTT and CBF images. The two T_max images display some dependence on the MTT, where increasing MTT leads to higher T max as previously predicted. This dependence was expected because the peak of the deconvolved R_pw(t) shifts towards larger time as MTT increases (compare the peak of the deconvolved R_pw(t) in FIG. 14 and FIG. 13). We expect this behavior to be a deconvolution artifact. Due to the increasing popularity of the T_max parameter in acute ischemic stroke PWI, the t_delay dependence on the perfusion estimates and the performance of the two T_max estimates was also investigated. New ‘circle map’ with increasing t_delay towards the centre of the circle keeping the remaining underlying perfusion parameters constant was produced (not shown). Two main conclusions can be made (i) the T̂interp_max estimates outperforms the T_max discretized with TR and again the FTtrunc and FTfermi yields better discrimination as compared to the other approaches due to increased precision. (ii) The MTT and CBF image for sSVD have some ‘shine through’ depending on t delay which we ascribe to the delay dependence known to affect sSVD estimates. In conclusion, we find that the proposed regularization levels outperforms the regularization levels from (Magn Reson Med 2003; 50(1):164-174) for all perfusion parameters investigated in spite of the lower accuracy. This was, however, most evident in simulation data. Moreover, by selecting the regularization level according to the width of the AIF, the precision is kept intact across a wide range of AIF widths (FIG. 4). The new T̂interp_max is shown to improve the T_max images, but the usefulness of T̂interp_max in clinical data (e.g. its predictive value) needs to be investigated further.

Regularization levels can be either global or local (voxel-dependent). The proposed regularization level is a global regularization level. We speculate that a potential drawback of adaptive regularization methods is that they lead to different accuracy (systematic bias) in neighbouring voxels which will appear as random noise in the final image. This hypothesis was tested in an MTT ‘circle map’ comparing oSVD and cSVD. The additional random noise from the different thresholds used in oSVD is most apparent in the noise free image (not shown) which means that the noise masks this effect for this specific combination of parameters.

FIG. 11 shows MTT values which are increasing towards the centre of the circle from MTT=2 s to MTT=16 s in steps of 2 s. CBV=4%. There are no delay between c_t and AIF and sigma_AIF=3 s. All images are normalized to ‘healthy side’ corresponding to CBF true=60 ml/100 ml/min, MTT=4 s and CBV=4%. SNR=40 and TR=1.5 s.

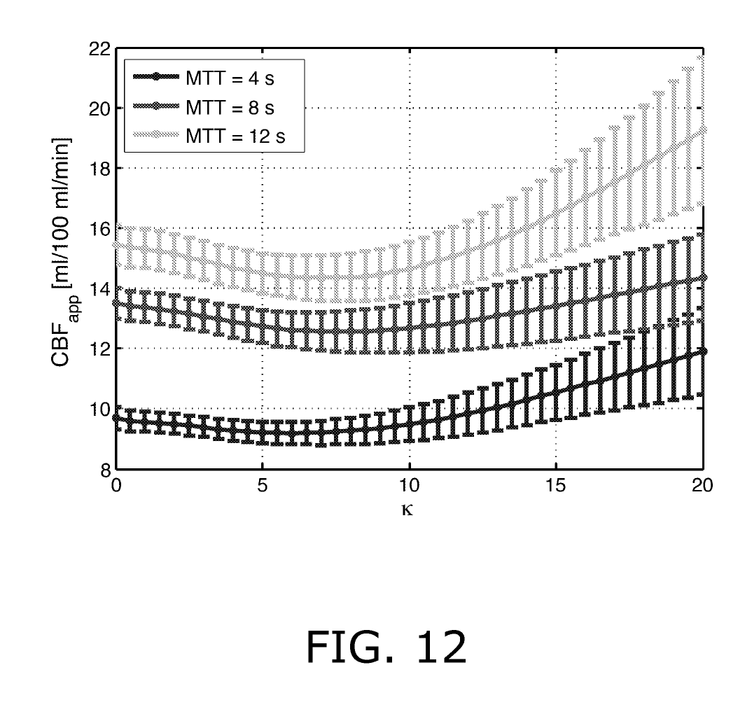

FIG. 12 shows the CBF estimates for different widths of the Fermi filter. Simulation of CBF true=20 ml/100 ml/min for TR=1 s, SNR=40 (100 noise realizations), t_length=120 s and sigma_AIF=3 s for three different MTT values and five different values of kappa in the Fermi filter, see FIGS. 13-14.

FIG. 13 shows: Column 1: mean (R_pw(omega)±std(R_pw(omega)) (black) and Fermi filters for different widths (grey). Note that kappa=0 corresponds to truncation (window function). Column 2: Corresponding mean (R_pw(t))±2·std(R_pw(t)) (black) and true R_pw (grey). 100 noise realizations, SNR=40, TR=1 s and σAIF=3 s. CBF=20 ml/100 ml/min and MTT=4 s. The oscillations in R_pw(t) are disappearing as the filter becomes more smooth (b increases).

FIG. 14 shows: Column 1: mean (R_pw(omega(±std(R_pw(omega)) (black) and Fermi filters for different widths (red). Note that kappa=0 corresponds to truncation (window function). Column 2: Corresponding mean (R_pw(t))±2·std(R_pw(t)) (black) and true R_pw (grey). 100 noise realizations, SNR=40, TR=1 s and sigma_AIF=3 s. CBF=20 ml/100 ml/min and MTT=12 s. The oscillations in R_pw(t) are disappearing as the filter becomes more smooth (b increases).

FIG. 15 shows: Comparison of the two different methods to obtain the optimal regularization level in FT according to a method where the cut-off is determined as the point of maximal curvature in the graph of mean(R_pw(omega)) versus epsilon*std(R_pw(omega)) (left) and a method where the cut-off is defined as the minimum of the error curve (equation 2). In this example TR=1.5 s, sigma_AIF=3 s, SNR=100 and MTT=6 s.

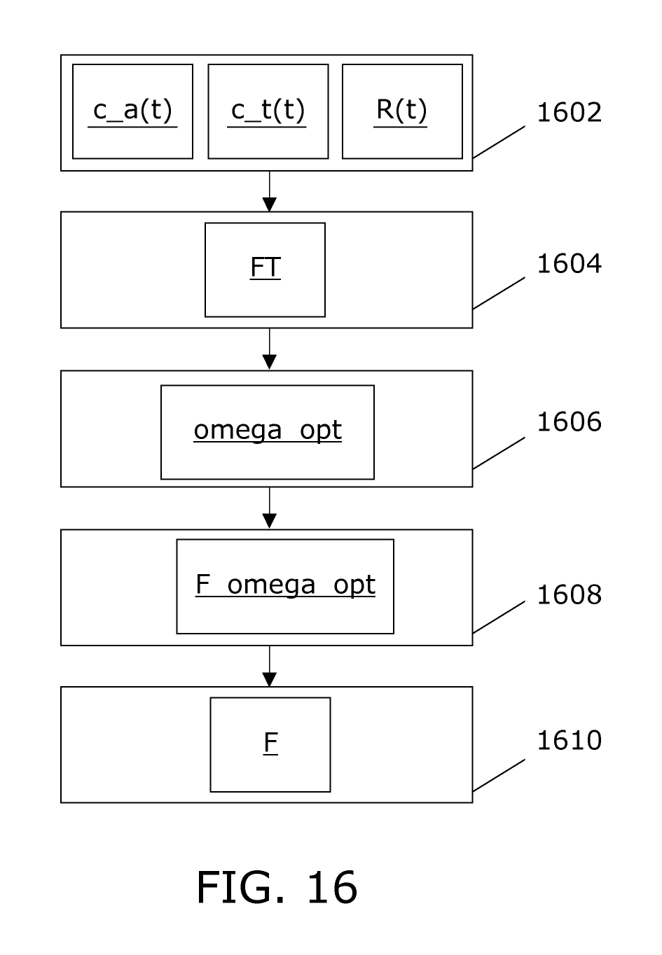

FIG. 16 shows a flow chart according to an embodiment of the invention, where in a first step 1602 comprises identifying a first concentration curve (c_t) representing a convolution of a second input concentration curve (c_a) convolved with a residue function (R), a second step 1604 comprises performing a deconvolution the first concentration curve (c_t) with the second input concentration curve (c_a), in the shown embodiment this deconvolution is carried out using a Fourier transform FT. A third step 1606 comprises determining a characteristic frequency omega_opt in a frequency domain, as a frequency above which noise dominates the result of the said deconvolution, said characteristic frequency being obtained by an analysis performed in the frequency domain, and a fourth step 1608 comprises applying a filter F_omega_opt on said result of the deconvolution, the filter having the characteristic frequency in the frequency domain thereby, at least partly, disregarding high frequency components in the frequency domain. A fifth step 1610 comprises processing the filtered data into a blood flow parameter F.

To sum up, the present invention relates to a method for obtaining a blood flow parameter. More particularly a method is presented wherein a first concentration curve is deconvolved with a second concentration curve and wherein a characteristic frequency is determined by an analysis in the frequency domain, the characteristic frequency being a frequency above which noise dominates the result of said deconvolution. A filter having the characteristic frequency is applied on the result of the deconvolution so as to disregard high frequency components, and the filtered result of the deconvolution is processed into a blood flow parameter. In an advantageous embodiment, the characteristic frequency may be dependent on a shape or width of an arterial input function or other parameter. The invention furthermore relates to a computer program product and a system for obtaining a blood flow parameter.

Below further discussion and exemplary embodiments are given.

In dynamic susceptibility contrast MRI perfusion weighted imaging (DSC-MRI PWI), the precision and accuracy of derived perfusion values rely critically on the noise dampening regularization used in the deconvolution process. The regularization parameters used in common deconvolution methods are optimized for the best reproducibility of true perfusion values across a range of physiologically realistic perfusion parameters based on a single, standardized arterial input function (AIF) shape. Here we show that this increased accuracy is obtained at the expense precision which negatively impacts the ability to identify critical hypoperfusion thresholds. We then present a framework for frequency-domain optimized regularization. This alternative approach allows application of low pass filters to the spectrum of the residue function, applicable to Fourier transform (FT) and block-circulant singular value decomposition (SVD) based deconvolution methods. The approach reveals that optimal regularization depends critically not only on signal to noise ratio (SNR), but also sampling rate (TR) and AIF shape. We present a look-up table of optimal regularization parameters across a range of AIF widths, SNRs and TRs. Application of the optimal regularization parameter to simulated data yields a better discrimination of hypoperfused tissue. We also present a strategy optimizing inter-subject comparisons important in patient cohort studies.

### Section A.1

Perfusion measurements by DSC-MRI have become an important tool in the study and management of neurological diseases, in particular acute stroke. Increasingly, tissue mean transit time (MTT) characteristics or normalized cerebral blood flow (CBF) values are compared across subjects and studied to establish perfusion threshold that may guide the selection of patients for thrombolytic treatment. In pursuing this, perfusion measurements must be optimized to detect and distinguish subtle levels of hypoperfusion, and standardized to allow comparison and application of results across academic centers.

When computing PWI maps, their accuracy and precision are determined by the deconvolution technique as well as the regularization applied during deconvolution to reduce the effects of experimental noise. Therefore, published deconvolution methods for DSC-MRI PWI are accompanied by extensive Monte Carlo simulation studies, seeking to optimize regularization for both accuracy (systematic bias) and precision (random error due to noise) in their estimates of the CBF and MU across a number of vascular characteristics (residue functions—see below) and physiological conditions (CBF, MTT, vascular delays and dispersion).

Deconvolution is most commonly performed using standard SVD (sSVD) or block-circulant SVD (cSVD) introduced by Wu et al. (Magn Reson Med 2003; 50(1):164-174) to allow for delay insensitive CBF and MTT estimates. Irrespective of technique, deconvolution is extremely noise sensitive, as it enhances the high frequency noise components, and regularization is necessary. Regularization may be performed using a simple cut-off (truncation) of higher frequencies (a rectangular low pass filter) or using a smooth filter such as a Fermi filter, Hanning filter and Tikhonov regularization. In addition, the oscillations in the estimated perfusion weighted residue function (R_pw) may be penalized using an oscillation index (OI) as suggested by Wu et al. (Magn Reson Med 2003; 50(1):164-174). They combined cSVD with OI and truncation in the oSVD method, which allows for adaptive regularization in individual voxels, whereas sSVD and cSVD usually are used with a global regularization parameter. The regularization approach profoundly affects the accuracy and precision of estimated perfusion parameters and must therefore be carefully optimized for the experimental setting: First, regularization parameters have been optimized using computer simulations to reproduce true CBF estimates. Due to an inherent tendency of regularization to cause underestimation of CBF (see below), this optimization for accuracy, however, comes at the expense of CBF (and MTT) precision. Secondly, regularizations are often optimized to standardized temporal resolutions and noise conditions. In a key paper, Wu et al. (Magn Reson Med 2003; 50(1):164-174.) presented regularization parameters of sSVD, cSVD and oSVD for TR of 1 s and 1.5 s and SNRs of 20 and 100 optimized for a single AIF shape. It is currently unclear whether the range of TRs and available SNRs in clinical studies bias reported perfusion indices—let alone how such bias may be corrected. Finally, regularization optimizations have been based on a single gamma variate model of the AIF. Contrast injection protocol and patient cardiovascular status, however, cause large variations in AIF shape among patients, influencing the perfusion estimates. Such variations may challenge meaningful inter-subject comparisons. Here we propose a new criterion for optimizing the regularization in DSCMRI PWI that favours precision in the perfusion estimates at the expense of accuracy. The increased precision assures better discrimination of perfusion thresholds whereas the decreased accuracy of perfusion estimates is not considered to be critical because (i) usually only relative perfusion estimates are derived and (ii) non of the currently used regularization thresholds provide true unbiased perfusion estimates. Optimization is performed directly on the spectrum of the residue function instead of the derived perfusion parameters, providing considerable computational efficacy. The proposed regularization level is determined from the specific TR, SNR and width of the AIF of the patient. Since these three parameters are unique for each patient, the proposed regularization level is global. We present results for truncation and Fermi filters and introduce a look-up table providing the optimal regularization level (optimal residue cut-off frequency) across a range of SNRs, TRs and AIFs. Finally, we discuss optimized regularization for achieving optimal inter-subject comparability in spite of different SNRs and AIF widths.

### Section A.2 Theory and Methods

### Section A.2.1 Basic Tracer Kinetics

The relationship between the concentration of contrast agent in the tissue, c_t(t), and a feeding artery, c_a(t), is modeled as

cₜ(t)=CBF·∫_{-∞}^{t}cₐ(T)R(t−τ)dτ, (Eq. A.1)

where R(t) is the residue function, which equals the fraction of contrast agent that remains within the volume of interest at time t after entering it. The CBF is estimated from Eq. A.1 by deconvolving the measured concentration curves and thereby obtaining the perfusion weighted residue function R_pw(t)=CBF·R(t). It follows theoretically, that CBF=R_pw(t=0) from the definition of the residue function R(t=0)=1 in the case of no delay between c_a(t) and c_t(t). In case of delay, the flow is best approximated by the maximum of R_pw(t). The cerebral blood volume (CBV) is usually obtained from

$$C B V = \frac{{\int }_{0}^{∞} {c}_{t} ( t ) d t}{{\int }_{0}^{∞} {c}_{a} ( t ) d t} , \qquad ( Eq . A .2 )$$

and once CBV and CBF are known, MTT can be calculated as the ratio of the two using the central volume theorem.

### Section A.2.2 Deconvolution

The cSVD procedure is described in (Magn Reson Med 2003; 50(1):164-174) and the obtained eigenvalues of the AIF is equal to the Fourier components, |c_a(omega)|, obtained from FT, up to a permutation due to the inherent property of SVD to sort the eigenvalues in descending order. In view of this equivalence, we use the Fourier deconvolution in what follows. Deconvolution using FT is given by the division:

$${R}_{pw} ( ω ) = \frac{{c}_{t} ( ω )}{{c}_{a} ( ω )} , \qquad ( Eq . A .3 )$$

where R_pw(omega) is the spectrum of R_pw(t) and c_t(omega) and c_a(omega) are the spectra of c_t(t) and the AIF respectively. It follows directly from the definition of FT that in case of no delay the CBF can be calculated as the area under R_pw(omega). Because R_pw(t) is a real function, the imaginary part is anti-symmetric and thereby does not contribute to the area calculation (and thereby CBF), therefore the following analysis will focus on the real part of R_pw(omega). Calculating an accumulated spectrum of real(R_pw(omega)) illustrates the convergence of R_pw(omega) as a function of increasing frequency according to

$$F ( {ω}_{c} ) = 2 {\int }_{- {ω}_{c}}^{{ω}_{c}} {R}_{pw} ( ω ) \frac{d ω}{2 π} , \qquad ( Eq . A .4 )$$

where omega_c is the cut-off frequency in the spectrum. The factor of two in front of the integral arises from the inherent periodic property of FT leading to interpolation at discontinuities, such as at t=0 where R_pw(t) theoretically increases from zero to CBF instantly causing the value at t=0 to be CBF/2 after FT. The accumulated spectrum shows the estimated CBF, CBF_app, as a function of the cut-off frequency (from the regularization) (FIG. 1). Both functions on the right-hand side of Eq. A.3 are decreasing functions of frequency with a peak around zero frequency (examples are given in FIG. 1, first and second rows). The functions crosses zero at some frequencies (FIG. 1) and thereby dive under the noise level. Since the spectrum of the AIF stays in the denominator of Eq. A.3 the noise in the AIF is strongly amplified at these frequencies. This results in high-magnitude oscillations in R_pw(t) at the corresponding frequencies, if they are not fully suppressed by the regularization.

### Section A.2.3 Regularization Techniques

The optimal low pass filter stabilizes the solution of Eq. A.3 by damping the high frequency parts of the spectrum that are dominated by noise. The optimal cut-off frequency in the low pass filter is expected to depend on the SNR, TR and the width of c_a(omega) and c_t(omega). The low pass filters used in the present study are (i) truncation (rectangular window filter in frequency domain) with cut-off frequency, omega_c, and (ii) Fermi filter given as

$$F ( ω ) = \frac{1 + exp ( - κ \cdot {ω}_{c} )}{1 + exp ( κ \cdot [ \vert ω \vert - {ω}_{c} ] )} , \qquad ( Eq . A .5 )$$

where kappa defines the width of the filter. In this study we used

kappa=4 Delta omega,

where Delta omega is the resolution in frequency domain after zero-padding in time domain by a factor two. The truncation filter is known to introduce more oscillations in R_pw(t) as compared to a smooth filter.

### Section A.2.4 Optimization Criterion

The optimal cut-off frequency, omega_opt, (regularization frequency) is operationally defined as the frequency above which the spectra are dominated by noise (FIG. 1). This cut-off can be thought of as the point where the trade off between the mean of R_pw(omega) (systematic bias) and standard deviation of R_pw(omega) (random error due to noise) shifts in favour of the standard deviation. This corresponds to the point of maximal curvature in the graph of mean(R_pw(omega)) versus std(R_pw(omega)). In a practical setting, due to noise, this maximal curvature approach is unreliable to identify the cut-off, even with the use of a smoothing filter. While the shape of the true R(t) is unknown, we chose to optimize the cut-off search for exponential-like R(t)'s. Its spectrum is a Lorentzian whose real part is a smooth, monotonically decreasing function. This encourages us to define the optimal cut-off as the minimum of the error curve, E(omega, epsilon):

E(ω,ε)=mean(R_{pw}(ω))+ε·std(R_{pw}(ω)). (Eq. A.6)

We used epsilon=1 in order to maintain spectral information (as epsilon increases, the optimal frequency decreases). We used a 5 point smoothing filter before minimizing E(omega, epsilon). The minimum of E(omega, epsilon) occurs where the measured spectrum of R(t) deviates from the true spectrum, readily identifiable in the spectrum (FIG. 1, last row). Our analysis showed that this point corresponds well to the trade off point defined above (results not shown), while being far more stable to implement. Using the simulation setup below, we created a look-up table for the optimal cut-off frequency for a range of SNR, TR and sigma_AIF.

### Section A.2.5 Simulation Setup

The perfusion simulations were performed as follows using Matlab.

### Section A.2.5.1 Perfusion Simulation

The simulations were performed as follows:

1. The c_a(t) was modeled as a gamma variate function, given as

$${c}_{a} ( t ) = \{ \begin{matrix}0 & if t \leq {t}_{0} , \\ K \cdot {( t - {t}_{0} )}^{α} {e}^{- ( t - {t}_{0} ) / β} & if t > {t}_{0} ,\end{matrix} \qquad ( Eq . A .7 )$$

where alpha and beta are shape parameters, and K is a scaling factor given as (betâ(alpha+1)*Tau*(alpha+1))̂(−1) in order to maintain unit AIF area. In the optimization simulations t_{—}0=0 s.

2. The tissue concentration, c_t(t) was calculated from Eq. A.1 using an exponential R(t). The convolution was performed in Fourier domain with analytical expressions of the gamma variate and the R(t). The Fourier transformed gamma variate is given as

$${c}_{a} ( ω ) = \frac{K \cdot Γ ( 1 + α ) \cdot {e}^{- i ω {t}_{0}}}{{( 1 / β + i ω )}^{α + 1}} . \qquad ( Eq . A .8 )$$

In particular, this formula describes the Fourier transform of the exponential R(t) for K=1, t_{—}0=0, alpha=0 and beta=MTT.

3. Sampling of the concentration curves were performed corresponding to the relevant TR and t_length, where t_length is the imaging duration.

4. The concentration curves were converted to signals using the formula

S(t)=S_{—}0·exp(−k·c(t)·TE),

where S_{—}0 is the baseline signal and k is a constant converting the concentrations into changes in relaxation rate, DeltaR*2(t). The constant k·TE was determined such that the maximal signal decrease in the AIF was 60% and the maximal decrease in the tissue signal was 40% (Magn Reson Med 2003; 50(1):164-174).

5. Gaussian noise was added to the signals with a given baseline SNR (1000 noise realizations were performed) according to

S=S_{noise free}+ε, where ε˜N(0,1/SNR²). (Eq. A.9)

Using c(t)=−1/k*TE ln(S(t)/S(0)), the signals were converted into concentration curves.

6. The concentration curves were deconvolved using FT given in Eq. A.3.

7. The error curve was calculated using Eq. A.6. If no minimum can be found omega_opt is set to omega_max given by the Nyquist theorem.

8. The above calculation of omega_opt (step 1-7) was performed 50 times for averaging.

### Section A.2.5.2 Parameters

The full simulation as described above, was performed using the parameters listed in Table 1. The width of the AIF, sigma_AIF, was varied in the simulations according to the following relation sigma_AIF=beta·sqrt(alpha+1), which defines sigma_AIF as the second moment of the gamma variate curve. sigma_AIF was varied for fixed alpha=3 and beta calculated from the above relation. The relation to full width half maximum (FWHM) for this specific alpha is approximately given as FWHM˜2.1*sigma_AIF obtained from a fit to experimental data. The range of sigma_AIF was chosen based on an analysis of experimental AIFs fitted to a gamma variate function where 68% of AIFs had a width between 2 s. and 4 s (FWHM in the range 4-9 s) but the full range were from 1.5 s up to 11 s. The CNR was constant in the simulations due to the constant k·TE in step 4 above.

TABLE A.1
Look-up table parameters

| Parameter | Parameter range |
|---|---|
| TR | [1, 1.5, 2, 2.5, 3] s |
| SNR | 20-120 in steps of 10 |
| CBV | 0.04 |
| MTT | 2-10 s in steps of 1 s |
| sigma_AIF | 2-10 s in steps of 0.25 s |

### Section A.3 Results

### Section A.3.1 Optimal Cut-Off Frequency

Three cross sections of the look-up table of omega_opt are shown in FIG. 2 for the parameters TR=1 s, t_length=120 s, SNR=40 and sigma_AIF=3 s and MTT=6 s. From the different cross sections, it is evident that omega_opt depends strongly on SNR, MTT and sigma_AIF. The relative change in omega_opt going from sigma_AIF=2 s to sigma_AIF=4 s is ˜44% and for SNR from 30 to 50 is ˜12% for MTT going from 4 s to 6 s is −9%. A dependence on t_length and the number of AIF averages were not observable except in the cases where t_length was not long enough to cover the full bolus passage due to wide AIF and/or long MTT. Note that the optimal frequency is subjected to a scaling. A simultaneous increase in all time parameters (TR, sigma_AIF, MTT) results in a proportional decrease in omega_opt. This can be used to reduce the dimensionality of the look-up table by one. We observe that narrow AIFs display a stronger MTT dependence of omega_opt. This is expected due to the wider spectrum of the AIF, see FIG. 2a, which allows the tissue spectrum to define the frequency at which noise dominates; omega_opt increases as MTT decreases (wider spectrum). In contrast, the width of the tissue spectrum (given by the MTT and sigma_AIF) is less important for very wide AIFs which gives a very narrow spectrum and thus not many points in the important part of the spectrum to be used in the perfusion calculation. Because MTT is not known a priori, we used MTT=6 s, well within the typical MTT range, in subsequent use of the look-up table. Note that omega_opt does not display a strong dependence of TR except in the case TR>2.5 s where insufficient sampling leads to strong aliasing artefacts (see discussion section) causing the strong ‘bend’ seen in the look-up table. Given a sufficient sampling of the concentration curves, the relation between TR and SNR behaves according to the principles of oversampling (FIG. 2d).

### Section A.3.2 Discrimination of CBFs and MTTs

The aim of the regularization approach was to improve the discrimination of the perfusion metrics. We therefore determined the precision of CBF_app and MTTapp compared to current regularization levels according to Wu et al. (Magn Reson Med 2003; 50(1):164-174.). We simulated CBF values from 10 to 60 ml/100 ml/min in steps of 10 ml/100 ml/min with CBV=4% for two noise levels, SNR=40 (SNR observed in our experimental data) and 100, TR=1 s, and compared different filters and regularization levels: The three methods cSVD, sSVD, oSVD with regularization levels according to Wu et al. (Magn Reson Med 2003; 50(1):164-174) and two methods applicable in frequency space: Truncation at omega_opt, termed truncation FT, and a Fermi filter (Eq. A.5), termed Fermi FT, using regularization levels from the look-up table (FIG. 2). The AIF was an average of 5 noise realizations of an AIF with sigma_AIF=3 s. The results are shown in FIG. 3. We note that the use of the proposed filters dramatically improves the discrimination of voxels with different MTT and CBF—especially for low CBF (high MTT). This improved precision clearly occurs at the expense of decreased accuracy for high CBF and low MTT. Also note the benefits of high SNR in discriminating small CBF or MTT differences.

### Section A.3.3 Precision and Accuracy Versus AIF Width

In FIG. 4, different CBF profiles (CBFtrue vs. CBF_app for CBV=4%) are shown for three different sigma_AIF. The first two columns are for truncation FT and the last column is for oSVD using the OI from (Magn Reson Med 2003; 50(1):164-174). The first row shows CBF profiles for the exponential R(t), and the second row shows the CBF profiles as a weighted mean across three R(t) models: exponential, rectangular and triangular. The third row shows the data from first row relative to simulated normal white matter tissue (CBF=22 ml/100 ml/min and CBV=2.5%).

Generally we found that the proposed regularization level led to good precision across different sigma_AIF in contrast to oSVD (FIG. 4). Averaging the derived CBFs over three different R(t) shapes decreased the precision for both truncation FT and oSVD, but most for oSVD. Normalizing the CBFs on normal white matter tissue leads to more comparable CBF profiles, however, the normalization does not completely eliminate the difference in the CBF profiles when using different regularization levels.

### Section A.4 Discussion

The frequency representation of the R(t) engaged here provides a general framework for optimizing regularization approaches, as demonstrated by the performance of truncation and Fermi-filters applied in frequency space. This representation allows for an intuitive understanding of the effects of TR, sigma_AIF, SNR and physiological parameters on the precision of derived perfusion metrics. Below we discuss the implications of these findings in relation to intra- and inter subject investigations and finally different deconvolution errors will be discussed in relation to sigma_AIF. 4.1 Improved CBF and MTT Discrimination in Hypoperfused Tissue.

The main result of this study is a markedly improved discrimination of both CBF_app and MTTapp (for CBV=4%) as compared to the estimates using the widely used regularization levels by Wu et al. in (Magn Reson Med 2003; 50(1):164-174) (FIG. 3). The use of the present regularization level may therefore improve the differentiation of subtle CBF or MTT differences proposed to distinguish salvageable tissue from tissue prone for infarction in stroke patients as compared to currently used regularization levels. The high precision of the perfusion estimates is obtained by selecting the regularization threshold according to the specific AIF, SNR and TR of the patient and it is maintained across different sigma_AIF which is not the case for the oSVD derived CBFs (FIG. 4, first row). The high precision is achieved at the expense of accuracy especially for high CBF values which, because we keep CBV constant, are associated with short MTTs (see below). We find that the accuracy increases as a function of decreasing sigma_AIF (FIG. 4a).

We observe that CBF_app derived from oSVD show decreased accuracy and precision as a function of increasing sigma_AIF even though the OI was kept constant (FIG. 4c).

The application of a smooth filter (Fermi) instead of the truncation filter did not visually influence the derived perfusion estimates (FIG. 3), the corresponding R(t)'s were, however, more smooth as expected (data not shown). The shape of the Fermi filter, Eq. A.5, must be optimized and further investigated in a dedicated study order to evaluate the performance as compared to the truncation filter. The proposed regularization level is global for each patient, we speculate that a global regularization level generally is preferable because voxel-wise optimization and thereby different regularization thresholds across an image introduce different accuracy and precision in neighbouring voxels which will appear as noise in the final image. Unfortunately, the accuracy does not only depend on the regularization level, but also on the underlying MTT and R(t). But when selecting a single regularization level for the entire image the systematic error caused by regularization is constant across the image for specific combinations of MTT and R(t). When normalizing the perfusion maps (relative perfusion parameters) on normal white matter tissue, part of the systematic error is eliminated (FIG. 4, third row), the systematic error between voxels with different underlying MTT and R(t) will, however, remain. We find that the variation in the different systematic errors of CBF_app across different R(t) is smaller for the proposed regularization method as compared to oSVD derived perfusion estimates (FIG. 4, second row).

### Section A.4.2 Inter-Subject Comparisons

It has been a growing concern that the shape of the AIF may have large effect on the estimated perfusion metrics and thereby greatly affect the extent to which e.g. perfusion thresholds could be derived from patient cohorts. Our results confirm that the AIF has great impact on both accuracy and precision of the derived perfusion metrics (FIG. 4). In most PWI studies, the AIF is selected globally and thereby is unique for this specific patient. Optimizing the regularization level for each patient lead to different individual optimal regularization levels. Because different regularization levels lead to different systematic errors in CBF_app we suggest to use a single global regularization level for the entire patient cohort (FIG. 4b). In order to preserve the improved precision (and discrimination) of the perfusion estimates for all patients in the cohort the single global omega_opt should theoretically be selected according to the most restrictive parameters of the patient cohort (SNR, sigma_AIF, TR), and practically selected for a wide but representative sigma_AIF and at a low but representative SNR in order to achieve comparable perfusion maps in terms of accuracy (systematic bias) (FIG. 4b and FIG. 4e). The TR should be as short as possible in the protocol. Using the above procedure we expect the high precision of perfusion maps can be maintained without introducing additional inter-subject systematic bias when analyzing perfusion maps from large patient cohorts studied under different experimental conditions. Relative perfusion estimates also benefit from this (FIG. 4h) because the systematic bias of the CBFs depends on MTT and R(t) in a nonlinear manner for different regularization levels leading to different shapes of the CBF profiles (FIGS. 4a and 4g). Even though the predictions from our simulations seems convincing (FIG. 4), this procedure must be investigated further in a clinical setting where additional errors are expected to be present arising from other sources such as differences in both experimental and physiological conditions between patients (such as differences in relaxivities and partial volume effects in the measured AIFs).

As mentioned above, there are some unavoidable systematic biases in the estimated perfusion parameters arising from the combination of the true underlying MTT and R(t). The origin of these biases is discussed in the following section.

### Section A.4.3 Deconvolution Errors

Deconvolution (and regularization) introduces systematic errors in the derived perfusion parameters. Using the frequency domain framework, the origin of these errors can be explained by comparing the spectra of the concentration curves (c_a(omega) or c_t(omega)) and the perfusion weighted residue function (R_pw(omega)) according to Eq. A.3. Generally, the information contained in R_pw(omega) is lost in the frequency regions where either of the two spectra c_a(omega) or c_t(omega) is noise dominated (FIG. 1). In this section, the following two limiting cases will be discussed (i) c_a(omega) is narrower than R_pw(omega) (FIG. 1, second column) and (ii) c_a(omega) is wider than R_pw(omega) (FIG. 1, first column). Finally aliasing is discussed.

### Section A.4.3.1 Broad AIF

c_a(omega) is narrower than R_pw(omega) (FIG. 1, second column) when the AIF is broad in time domain. In this situation the power of c_a(omega) falls below noise level at a frequency much lower than the highest frequency in R_pw(omega) (FIG. 1, second column), thereby introducing noise in the estimated R_pw(omega) before the spectrum is converged (FIG. 1). Because the shape of R_pw(omega) depends on both MTT and R(t), they will introduce systematic errors in CBF_app in the above-specified case. For the exponential R(t), the incomplete integration of R_pw(omega) leads to a systematic underestimation of CBF_app because the spectrum (a Lorentzian) theoretically is positive (FIG. 5a). For a given omega_opt, the level of CBF underestimation depends on MTT (FIG. 4), an effect observed in many other studies such as (Magn Reson Med 2003; 50(1):164-174). For other functional shapes, such as the rectangular R(t) that has negative lobes at high frequencies (FIG. 5a), overestimation may occur depending on the relevant omega_opt. Therefore variations of R(t) in individual voxels might result in a partially random appearance of this error on top of an overall systematic underestimation of CBF.

The true R(t) of the tissue is not known, and to the authors knowledge there has not been a study which confirms the relevance and distribution of the three R(t)'s which are typically considered in PWI simulations; the exponential, the rectangular and the triangular R(t). The exponential R(t) is normally considered to be the most realistic. In FIG. 4 second row, CBF_app is shown averaged over the three R(t)'s (equal weight). It is clear that the R(t)'s lead to a large variations in CBF_app, but we find that this variation is decreased when using the proposed more strict regularization. The asymptotic behavior of the residue spectra, FIG. 5b, determines how much influence the low pass filter has on the estimated R_pw(t) and thereby CBF. The asymptotic behavior of the exponential and triangular R(omega) is omega-2 whereas the rectangular R(omega) has a slower convergence given as omegâ(−1). Again, the rectangular R(t) is the most problematic due to the large oscillations and the slow convergence of the spectrum for large frequencies (FIG. 5b). The difference in CBF_app in measured data is, however, not expected to be so extensive as illustrated in FIG. 5 because the rectangular R(t) is unlikely to occur in this idealized shape with sharp edges. The overestimation of CBF for the rectangular function was also observed by Wu et al. (Magn Reson Med 2003; 50(1):164-174) showing overestimate for rectangular R(t) and underestimate of CBF for the other two functions. The use of a global AIF in the perfusion analysis introduces a vascular operator, h(t), that describes the traveling of the AIF from the measuring site to the tissue voxel. The vascular operator includes delay and dispersion and the latter smoothes our estimate of R_pw(t) because the vascular operator appears in our analysis as a convolution with the true R_pw(t). Due to the smoothing we expect a narrower spectrum of h(t) convolved with R_pw(t) which yields better convergence as discussed above in combination with a reduced CBF_app.

### Section A.4.3.2 Narrow AIF and Undersampling

The differences in CBF_app due to different R(t) shapes and MTTs are reduced when using an AIF which is narrow in the time domain. The corresponding wide spectrum of the AIF leave more of the spectrum free from noise dominance (FIG. 1). Too narrow AIFs, however, will be undersampled at the experimentally achievable TRs. The error depends on the actual sampling of the AIF time course. Inter-subject variations in the AIF timing, although identical underlying AIF shape, give rise to an error that appears random across subjects. Undersampling of the AIF also lead to aliasing. Aliasing occurs when the measured signal has spectral information at frequencies larger than the maximal frequency measured, omega_max=pi/TR. This is most likely to occur for narrow concentration curves (wide spectra). In FIG. 6, this aliasing effect caused by insufficient sampling is illustrated in the severe case for TR=3 s, sigma_AIF=3 s and MTT=4 s. The aliasing of c_t(omega) is not visible, but the aliasing in c_a(omega) is observed at the arrow labeled ‘A’. The imaginary part (which also contribute to the real part of R_pw(omega)) must—by the properties of the FT—maintain periodicity, causing inaccuracy at the zero-crossing at omegamax—see the arrow ‘B’ in FIG. 6. R(omega) is affected both in the real and imaginary part, as indicated in the figure with arrows ‘C’ and ‘D’. In general, aliasing depends closely on data sampling, AIF and MTT.

The effect of aliasing is evident from the omega_opt-look-up table when the aliasing overlaps the minimum in E(omega, epsilon), causing our minimum search to fail leading to the strong ‘bend’ in the look-up table, FIG. 2c, towards TR=3 s and high SNR. This can be understood from the spectrum seen in the lower left panel of FIG. 6, where the spectrum is seen to continue decreasing as a function of frequency (letter C in the figure) due to aliasing and thereby no minimum can be found. Aliasing has most impact on high frequency components and therefore we include more aliasing effects as the SNR increases due to the increasing amount of high frequency components above noise level. Summarizing the above, the main type of errors appearing in CBF_app after deconvolution are (i) systematic errors caused by different underlying R(t) shapes and widths (MTT) (ii) systematic errors caused by insufficient sampling of the AIF. The main task in the deconvolution is to suppress noise in the spectrum of the AIF, even if averaging in practical implementations reduces it. The shape of the AIF can be affected by the injection rate, which raises the question about its optimal width. This width should insure a good sampling, but not exceed the expected width of R_pw(t). There is little room for selecting this value given realistic measurement parameters. The optimal sigma_AIF should be close to the MTT, which is defined by the shape of the expected R(t). In conclusion, our results support the general recommendation of low TR and narrow, but sufficiently sampled, AIF. The AIF is sufficiently sampled when sigma_AIF>TR which corresponds to TR<FWHM/2.1 in terms of the FWHM of the AIFs.

### Section A.5 Limitations

We performed the optimization for exponential residue functions because we expect them to be the most biological relevant functions, but the optimization could be repeated for a combination of functions according to the methods by Wu et al. (Magn Reson Med 2003; 50(1):164-174.). But as seen from FIG. 5, it is very unlikely that a single cut-off frequency will provide equal perfusion estimates for the three residue functions (which were also the case in the results by Wu et al. (Magn Reson Med 2003; 50(1):164-174.)). All simulations have been performed for constant contrast to noise ratio (CNR) and for a more comprehensive look-up table, several relevant CNR levels needs to be investigated. The full shape dependence (not only width) of the AIF should also be further investigated, and the AIF shapes with other values of alpha. It might also be useful to repeat the simulation using a full circulation model.

### Section A.6 Summary

In conclusion, we find that the discrimination between different CBF and MTTs are markedly increased when using regularization optimized for precision (random error) at the expense of accuracy (systematic bias) by cutting the spectrum of the residue function at the highest frequency before the spectral information is masked in noise. As expected the best discrimination is obtained for fast sampling (TR), and a well sampled narrow AIF and high SNR. In large cohort studies we recommend to use the same frequency cut-off for all patients, which allows for a comparison with reduced bias on the estimates caused by differences in AIFs and SNR. We speculate that this will increase the efficiency of predictive models due to less method-induced variation between patients. We recommend the use of FT instead of cSVD for computational speed and a more intuitive filter design, such as the Fermi filter. Further investigations are needed in order to choose the optimal filters to be used in combination with the present optimal frequency cut-off.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for obtaining a blood flow parameter (F), comprising:
identifying a first concentration curve (c_t) representing a convolution of a second input concentration curve (c_a) convolved with a residue function (R),
performing a deconvolution of the first concentration curve (c_t) with the second input concentration curve (c_a),
determining a characteristic frequency by an analysis performed in a frequency domain, wherein the characteristic frequency in the frequency domain is chosen so as to optimise precision of said blood flow parameter as a frequency above which noise dominates the result of said deconvolution,
applying a filter on said result of the deconvolution (R_pw), the filter having the characteristic frequency in the frequency domain thereby, at least partly, disregarding high frequency components in the frequency domain, and
processing the filtered result of the deconvolution into a blood flow parameter (F).

2-14. (canceled)

15. The method according to claim 1, said analysis further comprising evaluation of the influence of noise on the deconvoluted data and/or the blood flow parameter.

16. The method according to claim 1, wherein the characteristic frequency is dependent on any one of: a shape and/or width of an arterial input function (AIF), a signal-to-noise ratio (SNR) of the result of the deconvolution, a sampling rate (TR), a mean transit time (MTT), and/or a CNR (contrast-to-noise ratio).

17. The method according to claim 1, wherein the characteristic frequency is determined by a look up table (LUT).

18. The method according to claim 1, wherein the filter is a continuous filter.

19. The method according to claim 1, wherein the filter is a step function.

20. The method according to claim 1, wherein the deconvolved data (R_pw) below the characteristic frequency is fitted to a mathematical model, and wherein the values of the fit above the characteristic frequency are used for processing the perfusion data into an image, or a clinical perfusion parameter.

21. The method according to claim 20, wherein the characteristic frequency in the spectral domain is chosen so as to favor precision of the blood flow parameter at the expense of proximity to true values.

22. The method according to claim 1, wherein the step of identifying a first concentration curve further includes identifying a plurality of concentration curves each corresponding to a voxel within a plurality of voxels, and wherein the characteristic frequency is determined globally for the plurality of voxels.

23. The method according to claim 1, wherein the step of identifying a first concentration curve further includes identifying a plurality of concentration curves each corresponding to a subject within a plurality of subjects, and wherein the characteristic frequency is determined globally for the plurality of subjects.

24. The method according to claim 1, wherein the step of identifying a first concentration curve further includes identifying a plurality of concentration curves each corresponding to a point in time within a plurality of points in time, and wherein the characteristic frequency is determined globally for the plurality of points in time.

25. The method according to claim 1, wherein the blood flow parameter is representative of a perfusion parameter.

26. A computer program product being adapted to enable a computer system comprising at least one computer having a data storage means associated therewith to operate a processor arranged for carrying out a method according to claim 1.

27. A system for obtaining a blood flow parameter (F), the system comprising at least one computer having a data storage means associated therewith to operate a processor arranged for carrying out a method according to claim 1.
